(19) United States
(12) Patent Application Publication
(10) Pub. No.: US 2009/0155638 A1
(43) Pub. Date: Jun. 18, 2009

(54) SYSTEM AND PROCESS FOR GENERATING ELECTRICAL POWER

(76) Inventors: Jingyu CUI, Katy, TX (US); Erik Edwin ENGWALL, Houston, TX (US); Mahendra Ladharam JOSHI, Katy, TX (US); Scott Lee WELLINGTON, Bellaire, TX (US)

Correspondence Address: SHELL OIL COMPANY, P O BOX 2463, HOUSTON, TX, 772522463, US

(21) Appl. No.: 12/335,382

(22) Filed: Dec. 15, 2008

Related U.S. Application Data
(60) Provisional application No. 61/014,244, filed on Dec. 17, 2007.

(51) Int. Cl. H01M 8/00; H01M 8/18

(52) U.S. Cl. 429/13

(57) ABSTRACT

The present invention relates to a process for generating electricity with a solid oxide fuel cell system. First and second gas streams containing hydrogen are fed at independently selected rates to an anode of a solid oxide fuel cell. The first and second gas streams are mixed with an oxidant at one or more anode electrodes of the solid oxide fuel cell to generate electricity. An anode exhaust stream comprising hydrogen and water is separated from the anode of the fuel cell, and the second gas stream comprising hydrogen is separated from the anode exhaust stream and fed back to the anode of the fuel cell. The rates that the first and second gas streams are fed to the fuel cell are selected so the fuel cell generates a high electrical power density.

This application claims the benefit of U.S. Provisional Application No. 61/014,244, filed Dec. 17, 2007, which is incorporated herein by reference.

### FIELD OF THE INVENTION

The present invention relates to electrical power generating fuel cell systems, and to a process for generating electrical power. In particular, the present invention relates to an electrical power generating solid oxide fuel cell system and a process for generating electrical power with such a system.

### BACKGROUND OF THE INVENTION

Solid oxide fuel cells are fuel cells that are composed of solid state elements that generate electrical power directly from an electrochemical reaction. Such fuel cells are useful in that they deliver high quality reliable electrical power, are clean operating, and are relatively compact power generators-making their use attractive in urban areas.

Solid oxide fuel cells are formed of an anode, a cathode, and a solid electrolyte sandwiched between the anode and cathode. An oxidizable fuel gas, or a gas that may be reformed in the fuel cell to an oxidizable fuel gas, is fed to the anode, and an oxygen containing gas, typically air, is fed to the cathode to provide the chemical reactants. The oxidizable fuel gas fed to the anode is typically syngas, a mixture of oxidizable components molecular hydrogen and carbon monoxide. The fuel cell is operated at a high temperature, typically from 650° C. to 1000° C., to convert oxygen in the oxygen containing gas to ionic oxygen that may cross the electrolyte to interact with hydrogen and/or carbon monoxide from the fuel gas at the anode. Electrical power is generated by the conversion of oxygen to ionic oxygen at the cathode and the chemical reaction of the ionic oxygen with hydrogen and/or carbon monoxide at the anode. The following reactions describe the electrical power generating chemical reactions in the cell:

Cathode charge transfer: O₂+4e⁻→2O⁻

Anode charge transfer: H₂+O⁻→H₂O+2e⁻ and CO+O⁻→CO₂+2e⁻

An electrical load or storage device may be connected between the anode and the cathode so an electrical current may flow between the anode and cathode, powering the electrical load or providing electrical power to the storage device.

Fuel gas is typically supplied to the anode by a steam reforming reactor that reforms a low molecular weight hydrocarbon and steam into hydrogen and carbon oxides. Methane, for example in natural gas, is a preferred low molecular weight hydrocarbon used to produce fuel gas for the fuel cell. Alternatively, the fuel cell anode may be designed to internally effect a steam reforming reaction on a low molecular weight hydrocarbon such as methane and steam supplied to the anode of the fuel cell.

Methane steam reforming provides a fuel gas containing hydrogen and carbon monoxide according to the following reaction: CH₄+H₂O⇄CO+3H₂. Typically, the steam reforming reaction is conducted at temperatures effective to convert a substantial amount of methane and steam to hydrogen and carbon monoxide. Further hydrogen production may be effected in a steam reforming reactor by conversion of steam and carbon monoxide to hydrogen and carbon dioxide in the water-gas shift reaction. Hydrogen and carbon dioxide are formed in the water-gas shift reaction according to the reaction: H₂O+CO⇄CO₂+H₂. In a conventionally operated steam reforming reactor used to supply a fuel gas to a solid oxide fuel cell, however, little hydrogen is produced by water-gas shift reaction since the steam reforming reactor is operated at a temperature that energetically favors the production of carbon monoxide and hydrogen by the steam reforming reaction and disfavors the production of hydrogen and carbon dioxide by the water-gas shift reaction. Carbon monoxide may be oxidized in the fuel cell to provide electrical energy while carbon dioxide cannot, therefore, conducting the reforming reaction at temperatures favoring the reformation of hydrocarbons and steam to hydrogen and carbon monoxide and disfavoring the shift reaction of carbon monoxide and steam to more hydrogen and carbon dioxide is typically accepted as a preferred method of providing fuel for the fuel cell. The fuel gas typically supplied to the anode by steam reforming, either externally or internally, therefore, contains hydrogen, carbon monoxide, and small amounts of carbon dioxide, unreacted methane, and water as steam.

Fuel gases containing non-hydrogen compounds such as carbon monoxide, however, are less efficient for producing electrical power in a solid oxide fuel cell than more pure hydrogen fuel gas streams. At a given temperature the electrical power that may be generated in a solid oxide fuel cell increases with increasing hydrogen concentration. This is due to the electrochemical oxidation potential of molecular hydrogen relative to other compounds. For example, molecular hydrogen can produce an electrical power density of 1.3 W/cm² at 0.7 volts while carbon monoxide can produce an electrical power density of only 0.5 W/cm² at 0.7 volts. Therefore, fuel gas streams containing significant amounts of non-hydrogen compounds are not as efficient in producing electrical power in a solid oxide fuel cell as fuel gases containing mostly hydrogen.

Solid oxide fuel cells, however, are typically operated commercially in a “hydrogen-lean” mode, where the conditions of the production of the fuel gas, for example by steam reforming, are selected to limit the amount of hydrogen exiting the fuel cell in the fuel gas. This is done to balance the electrical energy potential of the hydrogen in the fuel gas with the potential energy (electrochemical+thermal) lost by hydrogen leaving the cell without being converted to electrical energy.

Certain measures have been taken to recapture the energy of the hydrogen exiting the fuel cell, however, these are significantly less energy efficient than if the hydrogen were electrochemically reacted in the fuel cell. For example, the anode exhaust produced by reacting the fuel gas electrochemically in the fuel cell has been combusted to drive a turbine expander to produce electricity. This, however, is significantly less efficient that capturing the electrochemical potential of the hydrogen in the fuel cell since much of the thermal energy is lost rather than converted by the expander to electrical energy. Fuel gas exiting the fuel cell also has been combusted to provide thermal energy for a variety of heat exchange applications. Almost 50% of the thermal energy, however, is lost in such heat exchange applications after combustion. Hydrogen is a very expensive gas to use to fire a burner utilized in inefficient energy recovery systems, therefore, conventionally, the amount of hydrogen used in the solid oxide fuel cell is adjusted to utilize most of the hydrogen provided to the fuel cell to produce electrical power and minimize the amount of hydrogen exiting the fuel cell in the fuel cell exhaust.

U.S. Patent Application Publication No. 2007/0017369 (the '369 publication) provides a method of operating a fuel cell system in which a feed is provided to a fuel inlet of the fuel cell. The feed may include a mixture of hydrogen and carbon monoxide provided from an external steam reformer or, alternatively may include a hydrocarbon feed that is reformed to hydrogen and carbon monoxide internally in the fuel cell stack. The fuel cell stack is operated to generate electricity and a fuel exhaust stream that contains hydrogen and carbon monoxide, where the hydrogen and carbon monoxide in the fuel exhaust stream are separated from the fuel exhaust stream and fed back to the fuel inlet as a portion of the feed. The fuel gas for the fuel cell, therefore, is a mixture of hydrogen and carbon monoxide derived by reforming a hydrocarbon fuel source and hydrogen and carbon monoxide separated from the fuel exhaust system. Recycling at least a portion of the hydrogen from the fuel exhaust through the fuel cell enables a high operation efficiency to be achieved. The system further provides high fuel utilization in the fuel cell by utilizing about 75% of the fuel during each pass through the stack.

U.S Patent Application Publication No. 2005/0164051 provides a method of operating a fuel cell system in which a fuel is provided to a fuel inlet of the fuel cell. The fuel may be a hydrocarbon fuel such as methane; natural gas containing methane with hydrogen and other gases; propane; biogas; an unreformed hydrocarbon fuel mixed with a hydrogen fuel from a reformer; or a mixture of a non-hydrocarbon carbon containing gas such as carbon monoxide, carbon dioxide, oxygenated carbon containing gas such as methanol, or other carbon containing gas with a hydrogen containing gas such as water vapor or syngas. The fuel cell stack is operated to generate electricity and a fuel exhaust stream that contains hydrogen. A hydrogen separator is utilized to separate non-utilized hydrogen from the fuel side exhaust stream of the fuel cell. The hydrogen separated by the hydrogen separator may be re-circulated back to the fuel cell or may be directed to a subsystem for other uses having a hydrogen demand. The amount of hydrogen re-circulated back to the fuel cell may be selected according to electrical demand or hydrogen demand, where more hydrogen is re-circulated back to the fuel cell when electrical demand is high. The fuel cell stack may be operated at a fuel utilization rate of from 0 to 100%, depending on electrical demand. When the electrical demand is high, the fuel cell is operated at a high fuel utilization rate to increase electricity production—a preferred rate is from 50 to 80%.

Further improvement in the efficiency and power density in solid oxide fuel cell systems for producing electricity and solid oxide fuel cell processes for producing electricity is desirable.

### SUMMARY OF THE INVENTION

In one aspect the present invention is directed to a process for generating electricity, comprising: feeding a first gas stream containing hydrogen at a selected rate to an anode of a solid oxide fuel cell; feeding a second gas stream containing hydrogen at a selected rate to the anode of the solid oxide fuel cell; in the anode, mixing the first gas stream and the second gas stream with an oxidant at one or more anode electrodes of the solid oxide fuel cell to generate electricity at an electrical power density of at least 0.4 W/cm²; separating an anode exhaust stream comprising hydrogen and water from the anode of the solid oxide fuel cell; and separating the second gas stream from the anode exhaust stream, said second gas stream comprising hydrogen separated from the anode exhaust stream, wherein the rates that the first gas stream and the second gas stream are fed to the anode are independently selected so the ratio of the amount of water formed in the fuel cell to the amount of hydrogen in the anode exhaust is at most 1.0.

In another aspect, the present invention is directed to a process for generating electricity, comprising: feeding a first gas stream containing hydrogen at a selected rate to an anode of a solid oxide fuel cell; feeding a second gas stream containing hydrogen at a selected rate to the anode of the solid oxide fuel cell; in the anode, mixing the first gas stream and the second gas stream with an oxidant at one or more anode electrodes of the solid oxide fuel cell to generate electricity at an electrical power density of at least 0.4 W/cm²; separating an anode exhaust stream containing hydrogen and water from the anode of the solid oxide fuel cell; and separating the second gas stream from the anode exhaust stream, said second gas stream comprising hydrogen from the anode exhaust stream, wherein the rates that the first gas stream and the second gas stream are fed to the anode are independently selected so that the anode exhaust stream contains at least 0.6 mole fraction hydrogen.

In another aspect, the present invention is directed to a process for generating electricity, comprising: feeding a first gas stream containing a hydrogen source at a selected rate to an anode of a solid oxide fuel cell; feeding a second gas stream containing hydrogen at a selected rate to the anode of the solid oxide fuel cell; in the anode, reforming the first gas stream to provide hydrogen; in the anode, mixing the reformed first gas stream and the second gas stream with an oxidant at one or more anode electrodes of the solid oxide fuel cell to generate electricity at an electrical power density of at least 0.4 W/cm²; separating an anode exhaust stream comprising hydrogen and water from the anode of the solid oxide fuel cell; and separating the second gas stream from the anode exhaust stream, said second gas stream comprising hydrogen from the anode exhaust stream, wherein the rates that the first gas stream and the second gas stream are fed to the anode are independently selected so the ratio of amount of water formed in the fuel cell to the amount of hydrogen in the anode exhaust is at most 1.0.

### BRIEF DESCRIPTION OF THE DRAWINGS

FIG. 1 is a schematic drawing of a system of the present invention for practicing a process of the present invention.

FIG. 2 is a schematic drawing of a system of the present invention including a reforming reactor for practicing a process of the present invention.

FIG. 3 is a schematic drawing of a system of the present invention including a pre-reforming reactor and a reforming reactor for practicing a process of the present invention.

FIG. 4 is schematic drawing of a portion of a system of the present invention in which a hydrogen separation apparatus is located exterior of a reforming reactor.

FIG. 5 is a schematic drawing of a basic system of the present invention for producing electricity in accordance with a process of the present invention.

FIG. 6 is a schematic drawing of a basic system of the present invention for producing electricity in accordance with a process of the present invention in which a hydrogen separation apparatus is located exterior of a reforming reactor.

### DETAILED DESCRIPTION OF THE INVENTION

The present invention provides a highly efficient process for generating electricity at a high electrical power density in a system utilizing a solid oxide fuel cell, and a system for performing such a process.

The process of the present invention produces a higher electrical power density in a solid oxide fuel cell system than systems disclosed in the art by utilizing a hydrogen-rich fuel and minimizing rather than maximizing the per pass fuel utilization rate of the fuel cell, which is achieved by separating and recycling hydrogen captured from the fuel exhaust of the fuel cell and feeding the hydrogen from a feed and the recycle stream at selected rates to minimize the per pass fuel utilization.

In the process of the present invention the anode of a solid oxide fuel cell is flooded with hydrogen over the entire path length of the anode so that the concentration of hydrogen at the anode electrode available for electrochemical reaction is maintained at a high level over the entire anode path length, thereby maximizing the electrical power density of the fuel cell. Use of a hydrogen-rich fuel that is primarily, and preferably almost all, hydrogen in the process maximizes the electrical power density of the fuel cell system since hydrogen has a significantly greater electrochemical potential than other oxidizable compounds typically used in solid oxide fuel cell systems such as carbon monoxide.

The process of the present invention also maximizes the electrical power density of the fuel cell system by minimizing, rather than maximizing, the per pass fuel utilization rate of the fuel in the solid oxide fuel cell. The per pass fuel utilization rate is minimized to reduce the concentration of oxidation products, particularly water, throughout the anode path length of the fuel cell so that a high hydrogen concentration is maintained throughout the anode path length. A high electrical power density is provided by the fuel cell since an excess of hydrogen is present for electrochemical reaction at the anode electrode along the entire anode path length of the fuel cell. In a process directed to achieving a high per pass fuel utilization rate, for example greater than 60% fuel utilization, the concentration of oxidation products may comprise greater than 30% of the fuel stream before the fuel has traveled even halfway through the fuel cell, and may be several multiples of the concentration of hydrogen in the fuel cell exhaust so that the electrical power provided along the anode path may significantly decrease as the fuel provided to the fuel cell progresses through the anode.

The process of the present invention is also highly efficient since hydrogen not utilized to produce electricity in the fuel cell is separated from the anode exhaust of the fuel cell and recycled continuously back to the fuel cell. This enables production of a high electrical power density relative to the lowest heating value of the fuel by eliminating the problem associated with losing energy by hydrogen leaving the cell without being converted to electrical energy.

The system of the present invention is designed to permit hydrogen flooding of a solid oxide fuel cell with a hydrogen rich fuel to maintain the concentration of hydrogen at the anode electrode of the solid oxide fuel cell at a high level over the entire anode path length to maximize the electrical power density of the fuel cell. The system includes a hydrogen separation apparatus positioned between a reforming reactor and the anode of a solid oxide fuel cell, where the hydrogen separation apparatus may be utilized to separate hydrogen from a reformed gas and provide the hydrogen to the anode of the fuel cell. The system also is designed to recycle the anode exhaust of the fuel cell back into the anode of the fuel cell, preferably after removing water from the anode exhaust, since the exhaust is primarily formed of hydrogen and water when the fuel for the fuel cell is hydrogen. Hydrogen may be maintained at a high concentration over the entire anode path length without losing the electrochemical potential of hydrogen exiting the fuel cell by recycling the hydrogen back into the anode of the fuel cell.

As used herein, the term “hydrogen” refers to molecular hydrogen unless specified otherwise.

As used herein, the term “hydrogen source” refers to a compound from which free hydrogen may be generated, for example a hydrocarbon such as methane, or mixtures of such compounds, for example a hydrocarbon containing mixture such as natural gas.

As used herein, the “amount of water formed in the fuel cell per unit time” is calculated as follows: Amount of Water Formed in Fuel Cell per Unit Time=[Amount of Water Measured Exiting the Fuel Cell in the Anode Exhaust of the Fuel Cell Per Unit of Time of Measurement]−[Amount of Water Present in the Fuel Fed to the Anode of the Fuel Cell Per Unit of Time of Measurement]. For example, if measurements of the amount of water in a fuel fed to the anode of a fuel cell and exiting the fuel cell in the anode exhaust are taken for 2 minutes, where the measured amount of water in the fuel fed to the anode is 6 moles and the measured amount of water exiting the fuel cell in the anode exhaust is 24 moles, the amount of water formed in the fuel cell as calculated herein is (24 moles/2 minutes)−(6 moles/2 minutes)=12 moles/min−3 moles/min=9 moles/min.

As used herein, when two or more elements are described as “operatively connected” or “operatively coupled”, the elements are defined to be directly or indirectly connected to allow direct or indirect fluid flow between the elements. The term “fluid flow”, as used herein, refers to the flow of a gas or a fluid. When two or more elements are described as “selectively operatively connected” or “selectively operatively coupled”, the elements are defined to be directly or indirectly connected or coupled to allow direct or indirect fluid flow of a selected gas or fluid between the elements. As used in the definition of “operatively connected” or “operatively coupled” the term “indirect fluid flow” means that the flow of a fluid or a gas between two defined elements may be directed through one or more additional elements to change one or more aspects of the fluid or gas as the fluid or gas flows between the two defined elements. Aspects of a fluid or a gas that may be changed in indirect fluid flow include physical characteristics, such as the temperature or the pressure of a gas or a fluid, and/or the composition of the gas or fluid, e.g. by separating a component of the gas or fluid, for example, by condensing water from a gas stream containing steam. “Indirect fluid flow”, as defined herein, excludes changing the composition of the gas or fluid between the two defined elements by chemical reaction, for example, oxidation or reduction of one or more elements of the fluid or gas.

As used herein, the term “selectively permeable to hydrogen” is defined as permeable to molecular hydrogen or elemental hydrogen and impermeable to other elements or compounds such that at most 10%, or at most 5%, or at most 1% of the non-hydrogen elements or compounds may permeate what is permeable to the molecular or elemental hydrogen.

As used herein, the term “high temperature hydrogen-separation device” is defined as a device or apparatus effective for separating hydrogen, in molecular or elemental form, from a gas stream at a temperature of at least 250° C., typically at temperatures of from 300° C. to 650° C.

As used herein, “per pass hydrogen utilization” as referring to the utilization of hydrogen in a fuel in a solid oxide fuel cell, is defined as the amount of hydrogen in a fuel utilized to generate electricity in one pass through the solid oxide fuel cell relative to the total amount of hydrogen in a fuel input into the fuel cell for that pass. The per pass hydrogen utilization may be calculated by measuring the amount of hydrogen in a fuel fed to the anode of a fuel cell, measuring the amount of hydrogen in the anode exhaust of the fuel cell, subtracting the measured amount of hydrogen in the anode exhaust of the fuel cell from the measured amount of hydrogen in the fuel fed to the fuel cell to determine the amount of hydrogen used in the fuel cell, and dividing the calculated amount of hydrogen used in the fuel cell by the measured amount of hydrogen in the fuel fed to the fuel cell. The per pass hydrogen utilization may be expressed as a percent by multiplying the calculated per pass hydrogen utilization by 100.

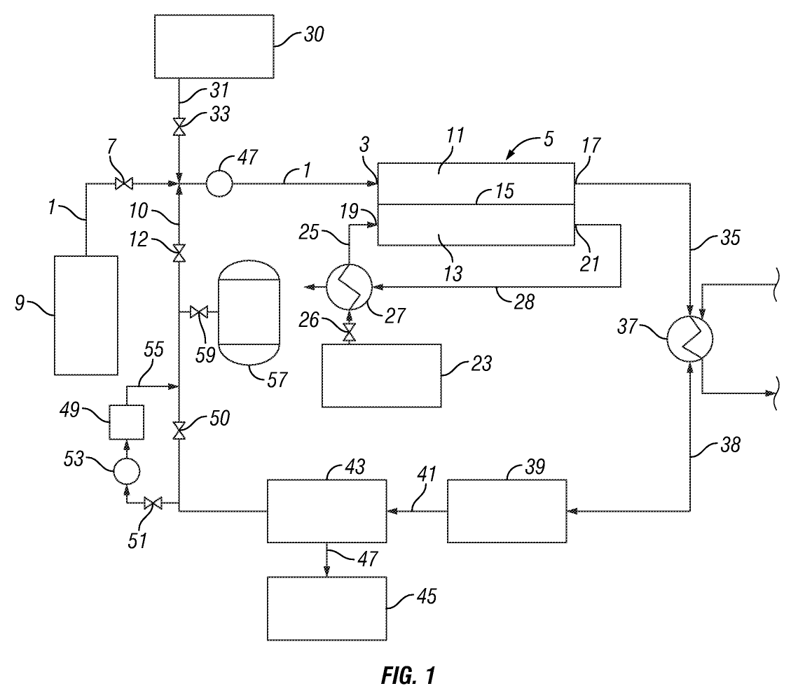

Referring now to FIG. 1, a process of the present invention will be described. In a process of the present invention, a first gas stream containing hydrogen or a hydrogen source is fed though line 1 to anode inlet 3 of a solid oxide fuel cell 5. Metering valve 7 may be used to select and control the flow rate of the first gas stream to the solid oxide fuel cell 5. In an embodiment, the first gas stream may contain at least 0.6, or at least 0.7, or at least 0.8, or at least 0.9, or at least 0.95, or at least 0.98 mole fraction hydrogen.

In an embodiment of the process of the present invention, a hydrogen generator 9 that generates hydrogen from a feed containing a hydrocarbon may be operatively connected to the solid oxide fuel cell 5 through line 1, where the hydrogen generator 9 may generate the first gas stream to be fed to the solid oxide fuel cell 5 or may generate a product gas containing hydrogen and one or more other compounds from which the first gas stream containing hydrogen may be separated and then fed to the solid oxide fuel cell 5. For purposes of the process of the present invention, the phrase “generating a first gas stream containing hydrogen from a feed containing one or more hydrocarbons” is intended to include directly generating the first gas stream, e.g. by forming a product gas containing hydrogen and one or more other compounds, and indirectly generating the first gas stream by first generating a product gas from the feed, for example by steam reforming the feed or catalytic partial oxidation of the feed, and separating the first gas stream from the product gas. The hydrogen generator 9 may be a hydrocarbon reforming reactor, a hydrocarbon reforming reactor operatively coupled to or integrating a high temperature hydrogen separation device, a catalytic partial oxidizing reactor, or a catalytic partial oxidizing reactor operatively coupled to a high temperature hydrogen separation device. Alternatively, a direct hydrogen supply, such as a storage tank of hydrogen, may be operatively connected to the solid oxide fuel cell 5 to provide the first gas stream to the anode inlet 3 of the fuel cell 5 via line 1.

If the hydrogen generator 9 is a hydrocarbon reforming reactor, the hydrocarbon reforming reactor may be any suitable device that converts one or more hydrocarbons and steam to hydrogen and carbon oxides, preferably including a conventional reforming catalyst to lower the energy required to effect the reaction. A hydrocarbon feed, preferably a low molecular weight hydrocarbon or mixtures of low molecular weight hydrocarbons, and steam are fed to the hydrocarbon reforming reactor for the reaction, preferably after scrubbing sulfur from the hydrocarbon feed to avoid poisoning the reforming catalyst. Preferably the hydrocarbon feed is a methane containing gas stream and the hydrocarbon reforming reactor is a steam reforming reactor for reforming the methane containing gas stream to hydrogen and carbon oxides by a steam reforming reaction. The reforming reactor may also effect a water-gas shift reaction to create further hydrogen from steam and carbon monoxide present as a result of the reforming reaction, depending on the temperature at which the steam reforming reactor is operated. The steam reforming reactor may be operated at a temperature of from 650° C. to 1000° C., or, as described below when used in conjunction with a high temperature hydrogen separating device, at a temperature of from 400° C. to 650° C., to effect the reforming reaction to convert methane or other hydrocarbon gas to hydrogen and carbon oxides. The methane/hydrocarbon-steam reforming reaction to produce hydrogen and carbon oxides is very endothermic, and use of higher temperatures favors the production of hydrogen. In an embodiment, natural gas is fed to a reforming reactor at a pressure of 2.5 MPa to 3 MPa and reacted therein with steam at a temperature of from 800° C. to 1000° C. to produce a reformed product gas containing hydrogen and carbon monoxide, which may be fed to the anode 11 of the fuel cell 5 as the first gas stream through line 1.

In an embodiment, the hydrogen generator 9 may be a hydrocarbon reforming reactor for reforming a feed comprising gaseous hydrocarbons coupled with a pre-reforming reactor for vaporizing, cracking, and/or reforming a feed precursor comprising liquid hydrocarbons to form the feed. A feed precursor comprising hydrocarbons that are liquid at a temperature of from 0° C. to 350° C. at atmospheric pressure may be fed to the pre-reforming reactor for reaction with steam at a temperature of from 400° C. to 1000° C. The feed precursor and steam, where the ratio of steam to feed precursor is at least 2, or at least 3, or at least 4, or at least 5, may be mixed in the pre-reforming reactor, preferably contacting a pre-reforming catalyst, to vaporize, and optionally crack and/or reform the feed precursor to form a gaseous hydrocarbon feed that may be fed to the reforming reactor. In an embodiment, the gaseous hydrocarbon feed produced from the feed precursor in the pre-reforming reactor may comprise at least 50%, or at least 60%, 70% methane.

In a preferred embodiment, a hydrocarbon reforming reactor is either operatively connected to a high temperature hydrogen-separation device or includes a high temperature hydrogen separation device within the reforming reactor. The high temperature hydrogen-separation device may comprise a member that is selectively permeable to hydrogen, either in molecular or elemental form. In a preferred embodiment, the high temperature hydrogen-separation device comprises a membrane that is selectively permeable to hydrogen. In an embodiment, the high temperature hydrogen-separation device comprises a tubular membrane coated with palladium or a palladium alloy that is selectively permeable to hydrogen.

If the high temperature hydrogen-separation device is operatively connected to the reforming reactor rather than located within the reactor, the high temperature hydrogen-separation device is operatively connected to the reforming reactor so that the reformed product gas from the reforming reactor containing hydrogen and carbon oxides is contacted with the high temperature hydrogen-separation device to separate hydrogen from other compounds in the reformed product gas. The hydrogen separated from the reformed product gas by the high temperature hydrogen-separation device may be fed to an anode 11 of the solid oxide fuel cell 5 through line 1 as the first gas stream.

If a high temperature hydrogen-separation device is located in the reforming reactor, it may be located in a position such that the reformed product gas contacts the selectively hydrogen permeable member of the high temperature hydrogen-separation device in the reforming region of the reforming reactor, and hydrogen is separated from the reforming region as the reforming reaction is effected. The high temperature hydrogen-separation device may have a hydrogen outlet which may be operatively coupled to the anode 11 of the solid oxide fuel cell 5 through line 1 so that hydrogen separated by the high temperature hydrogen separating device in the reforming reactor may be fed to the anode 11 of the fuel cell 5 from the reforming reactor as the first gas stream.

Use of a steam reforming reactor in conjunction with a high temperature hydrogen-separation device, either operatively connected to the steam reforming reactor or located in the reactor: 1) enables the hydrogen concentration of the first gas stream to be selected in a range from that produced by a conventional steam reforming reactor to essentially only hydrogen; 2) enables the steam reforming reaction to be run at a lower temperature, e.g. from 400° C. to 650° C.; and 3) enables more hydrogen to be produced per unit of hydrocarbon fuel than possible in a conventional steam reforming reactor since both steam reforming and water-gas shift reactions may occur in the reactor at the lower temperatures at which the reactor may be run, and these equilibrium reactions are driven to completion by removal of hydrogen from the reformed product.

In an embodiment of the process, the hydrogen generator 9 is a steam reforming reactor containing a conventional reforming catalyst and high temperature hydrogen-separation device, preferably comprising one or more tubular palladium coated membranes selectively permeable to hydrogen, where the feed to the steam reforming reactor is selected to be steam and methane or natural gas, and the operating temperature of the reforming reactor is selected to be from 400° C. to 650° C. At the selected temperature the reforming reactor effects a steam reforming reaction on the feed, converting methane and water to hydrogen and carbon monoxide, and effects a water gas shift reaction converting carbon monoxide and steam to hydrogen and carbon dioxide. The hydrogen separation device separates hydrogen produced in the reforming reactor which is delivered to an anode inlet 3 of the solid oxide fuel cell 5 through line 1 as the first gas stream. Separation of the hydrogen from the reforming reactor drives the reforming reaction and the water gas shift reaction to produce more hydrogen from the feed and steam. Alternatively, the hydrogen separation device may be located outside of the reforming reactor as described above, and the reforming reactor may be operated at a temperature selected from 400° C. to 650° C., where separation of hydrogen from the reformed product by the hydrogen separation device drives the reforming reaction and the water gas shift reaction to produce more hydrogen from the feed and steam.

In an embodiment of the process, a reforming reactor may be used in combination with a high temperature hydrogen-separation device, where the operating temperature of the reforming reactor may be selected to be greater than 650° C. and up to 1000° C. At these operating temperatures, the high temperature hydrogen-separation device is preferably located outside the reforming reactor since such high operating temperatures may detrimentally affect the performance of the high temperature hydrogen-separation device. In an embodiment, when the operating temperature of the reforming reactor is selected to be above 650° C., a heat exchanger may be operatively connected between the outlet of the reforming reactor and the hydrogen separation device to cool the reformed product gas exiting the reforming reactor to a temperature of 650° C. or less prior to contact with the hydrogen separation device. The heat exchanger may be used to heat steam or feed entering the reforming reactor, or alternatively, a feed precursor entering a pre-reforming reactor coupled to the reforming reactor. The cooled reformed product gas stream may then be contacted with the high temperature hydrogen-separation device to separate a hydrogen stream from the cooled reformed product gas stream, and the separated hydrogen stream may be delivered to an anode 11 of the fuel cell 5 as the first gas stream.

In another embodiment of the process, the hydrogen generator 9 may be a catalytic partial oxidation reforming reactor. If the hydrogen generator is a catalytic partial oxidation reforming reactor, the partial oxidation reforming reactor may be any suitable device that combusts a hydrocarbon feed and an oxygen source to hydrogen and carbon oxides and that includes a conventional partial oxidation catalyst to lower the energy required to effect the reaction. The hydrocarbon feed—preferably natural gas or low molecular weight hydrocarbons including gaseous low molecular weight hydrocarbons such as methane, propane, and butane, and liquid low molecular weight hydrocarbons such as naphtha, kerosene, and diesel—and an oxygen source, preferably air, are fed to the catalytic partial oxidation reactor so that oxygen is present in a substoichiometric ratio to the hydrocarbon in the feed. The feed must be relatively free of sulfur to prevent poisoning the catalyst, therefore, if necessary, the hydrocarbon feed may be scrubbed of sulfur prior to being fed to the catalytic partial oxidation reactor. The hydrocarbon feed and oxygen source may be combusted together in the presence of the partial oxidation catalyst in the catalytic partial oxidation reforming reactor to form partial oxidation product gas containing hydrogen and carbon monoxide. The combustion may be effected at a temperature of from 800° C. to 1000° C. or higher. The catalytic partial oxidation reforming reactor may be operatively connected to the anode 11 of the solid oxide fuel cell 5 through line 1 so that hydrogen and carbon monoxide produced in the partial oxidation reforming reactor may fed to the anode 11 of the solid oxide fuel cell 5 as the first gas stream.

In an embodiment, the partial oxidation product gas may be cooled by heat exchange before being fed to the anode 11 of the fuel cell 5. The partial oxidation product gas may exchange heat in a heat exchanger where the heat from the partial oxidation product gas may be used to heat steam or feed entering the reforming reactor, or alternatively, a feed precursor entering a pre-reforming reactor coupled to the reforming reactor. The cooled partial oxidation product gas may then be delivered to the anode 11 of the fuel cell 5 as the first gas stream.

In an embodiment of the process, the hydrogen generator 9 is a catalytic partial oxidizing reforming reactor operatively connected to a high temperature hydrogen separation device. The high temperature hydrogen separation device, preferably comprising a tubular palladium coated membrane selectively permeable to hydrogen, may be operatively connected to the outlet of the partial oxidizing reforming reactor so that hydrogen may be separated from carbon oxides and other compounds in the partial oxidation product gas from the partial oxidizing reforming reactor. The high temperature hydrogen separation device may be operatively connected to an anode inlet 3 of the solid oxide fuel cell 5 through line 1 so hydrogen separated from the partial oxidation product gas may be fed to the anode 11 of the solid oxide fuel cell 5. In an embodiment, the catalytic partial oxidizing reactor and the high temperature hydrogen separation device are operatively connected through a heat exchanger, where the heat exchanger cools the output gases from the catalytic partial oxidizing reactor to a temperature of 650° C. or less before the output gases contact the hydrogen separation device.

In the process of the present invention, a first gas stream generated by a hydrogen generating device 9 such as a reforming reactor or a catalytic partial oxidation reactor may contain at least 0.6, or at least 0.7, or at least 0.8, or at least 0.9, or at least 0.95 mole fraction hydrogen. The first gas stream containing such high amounts of hydrogen may be provided to the solid oxide fuel cell 5 by separating hydrogen from the reaction product gases of a reforming reactor or a catalytic partial oxidation reactor, preferably with a high temperature hydrogen-separation device as described above. In an embodiment, the first gas stream generated by a hydrogen generator 7 may have a temperature of from 350° C. to 600° C. as it is fed to the anode 11 of the fuel cell 5.

Alternatively, the first gas stream may be a steam and hydrocarbon feed containing low molecular weight hydrocarbons that may act as a hydrogen source, preferably methane or natural gas, that is fed to the anode of the solid oxide fuel cell 5. The hydrocarbon feed and steam may be reformed to hydrogen and carbon oxides internally in the solid oxide fuel cell to provide fuel to generate electricity in the fuel cell. In an embodiment, a first gas stream comprising a hydrocarbon feed containing a hydrogen source fed to the anode of the fuel cell 5 may be heated to a temperature of at least 300° C., or from 350° C. to 650° C., by heat exchange with an anode exhaust stream exiting the fuel cell 5 to provide heat to drive the endothermic reforming reaction in the fuel cell 5.

In a process of the present invention, a second gas stream containing hydrogen is fed to the anode 11 through an anode inlet 3 of the solid oxide fuel cell 5 via lines 10 and 1. The second gas stream is generated from an anode exhaust stream, as described in further detail below. The second gas stream fed to the fuel cell 5 may contain at least 0.8, at least 0.9, at least 0.95, or at least 0.98 mole fraction hydrogen. Metering valve 12 may be used to select and control the flow rate of the second gas stream fed into the anode 11 of the fuel cell 5. The second gas stream fed to the fuel cell 5 may be fed to the same anode inlet 3 as the first gas stream, or may be mixed with the first gas stream prior to being fed to the anode inlet 3 by connecting line 10 and line 1 (as shown), or may be fed into the anode 11 of the fuel cell 5 through a separate anode inlet 3 than the first gas stream is fed into the fuel cell 5 (not shown).

In the process of the present invention, the solid oxide fuel cell 5 may be a conventional solid oxide fuel cell, preferably having a tubular or planar configuration, and is comprised of an anode 11, a cathode 13, and an electrolyte 15 where the electrolyte 15 is interposed between and contacts the anode 11 and cathode 13. The solid oxide fuel cell 5 may be comprised of a plurality of individual fuel cells stacked together-joined electrically by interconnects and operatively connected so that the first and second gas streams may flow through the anodes of the stacked fuel cells and an oxygen containing gas may flow through the cathodes of the stacked fuel cells. As used herein, the term “solid oxide fuel cell” is defined as either a single solid oxide fuel cell or a plurality of operatively connected or stacked solid oxide fuel cells. The fuel cell is configured so that the first and second gas streams may flow through the anode 11 of the fuel cell from an anode inlet 3 to an anode exhaust 17, contacting one or more anode electrodes over the anode path length from the anode inlet 3 to the anode exhaust 17. The fuel cell is also configured so that an oxygen containing gas may flow through the cathode 13 from a cathode inlet 19 to a cathode exhaust 21, contacting one or more cathode electrodes over the cathode path length from a cathode inlet 19 to the cathode exhaust 21. The electrolyte 15 is positioned in the fuel cell to prevent the first and second gas streams from entering the cathode and to prevent the oxygen containing gas from entering the anode, and to conduct ionic oxygen from the cathode to the anode for electrochemical reaction with oxidizable compounds in the anode gas stream such as hydrogen and, optionally, carbon monoxide at the one or more anode electrodes.

Gas streams are fed to the anode and cathode to provide the reactants necessary to generate electricity in the fuel cell 5. As discussed above, a first gas stream containing hydrogen or a hydrogen source and a second gas stream containing hydrogen are fed to the anode 11 of the solid oxide fuel cell 5 through one or more anode inlets 3. An oxygen containing gas stream is fed from an oxygen containing gas source 23 to a cathode inlet 19 of the fuel cell 5 through line 25. Metering valve 26 may be used to select and control the rate the oxygen containing gas stream is fed to the cathode 13 of the fuel cell 5.

The oxygen containing gas stream may be air or pure oxygen. In an embodiment, the oxygen containing gas stream may be oxygen enriched air having containing at least 21% oxygen. The oxygen containing gas may be heated in a heat exchanger 27 prior to being fed to the cathode 13 of the fuel cell 5, preferably by exchanging heat with an oxygen-depleted cathode exhaust stream exiting the cathode exhaust 21 of the fuel cell 5 and connected to the heat exchanger 27 through line 28. In an embodiment, the oxygen containing gas may be heated to a temperature of from 150° C. to 350° C. prior to being fed to the cathode 13 of the fuel cell 5. In an embodiment, the oxygen containing gas is provided to the fuel cell 5 by an air compressor 23 operatively connected to the cathode 13 of the fuel cell 5 through heat exchanger 27 and the cathode inlet 19.

In the process of the invention, the first gas stream and the second gas stream are mixed with an oxidant at one or more of the anode electrodes of the solid oxide fuel cell 5 to generate electricity. The oxidant is preferably ionic oxygen derived from oxygen in the oxygen-containing gas stream flowing through the cathode 13 of the fuel cell 5 and conducted across the electrolyte of the fuel cell. The first gas stream, the second gas stream, and the oxidant are mixed in the anode at the one or more anode electrodes of the fuel cell 5 by feeding the first gas stream, the second gas stream, and the oxygen containing gas stream to the fuel cell 5 at selected independent rates, as discussed in further detail below. The first gas stream, the second gas stream, and the oxidant are preferably mixed at the one or more anode electrodes of the fuel cell to generate electricity at an electrical power density of at least 0.4 W/cm², or at least 0.5 W/cm², or at least 0.75 W/cm², or at least 1 W/cm², or at least 1.25 W/cm², or at least 1.5 W/cm².

The solid oxide fuel cell 5 is operated at a temperature effective to enable ionic oxygen to traverse the electrolyte 15 from the cathode 13 to the anode 11 of the fuel cell 5. The solid oxide fuel cell 5 may be operated at a temperature of from 700° C. to 1100° C., or from 800° C. to 1000° C. The oxidation of hydrogen with ionic oxygen at the one or more anode electrodes is a very exothermic reaction, and the heat of reaction generates the heat required to operate the solid oxide fuel cell 5. The temperature at which the solid oxide fuel cell is operated may be controlled by independently controlling the temperature of the first gas stream, the second gas stream, and the oxygen containing gas stream and the rates at which these gas streams are fed to the fuel cell. In an embodiment, the temperature of the second gas stream fed to the fuel cell is controlled to a temperature of at most 100° C., the temperature of the oxygen containing gas stream is controlled to a temperature of at most 300° C., and the temperature of the first gas stream is controlled to a temperature of at most 550° C. to maintain the operating temperature of the solid oxide fuel cell in a range from 700° C. to 1000° C., and preferably in a range of from 800° C. to 900° C.

To initiate operation of the fuel cell 5, the fuel cell 5 is heated to its operating temperature. In a preferred embodiment, operation of the solid oxide fuel cell 5 may be initiated by generating a hydrogen containing gas stream in a catalytic partial oxidation reforming reactor 30 and feeding the hydrogen containing gas stream through lines 31 and 1 to the anode 11 of the solid oxide fuel cell. A hydrogen containing gas stream may be generated in the catalytic partial oxidation reforming reactor 30 by combusting a hydrocarbon feed and an oxygen source in the catalytic partial oxidation reforming reactor 30 in the presence of a conventional partial oxidation reforming catalyst, where the oxygen source is fed to the catalytic partial oxidation reforming reactor 30 in a substoichiometric amount relative to the hydrocarbon feed.

The hydrocarbon feed fed to the catalytic partial oxidation reforming reactor 30 may be a liquid or gaseous hydrocarbon or mixtures of hydrocarbons, and preferably is methane, natural gas, or other low molecular weight hydrocarbon or mixture of low molecular weight hydrocarbons. In an embodiment, if the hydrogen source 9 is a hydrocarbon reforming reactor, the hydrocarbon feed fed to the catalytic partial oxidation reforming reactor 30 may a feed of the same type as used in the hydrogen source 9 hydrocarbon reforming reactor to reduce the number of hydrocarbon feeds required run the process. In another embodiment, when the hydrogen source 9 is a catalytic partial oxidation reforming reactor, the hydrogen source 9 may serve as the catalytic partial oxidation reforming reactor used to initiate operation of the fuel cell 5 so that no additional catalytic partial oxidation reforming reactor 30 is necessary.

The oxygen containing feed fed to the catalytic partial oxidation reforming reactor 30 may be pure oxygen, air, or oxygen enriched air. Preferably the oxygen containing feed is air. The oxygen containing feed should be fed to the catalytic partial oxidation reforming reactor 30 in substoichiometric amounts relative to the hydrocarbon feed to combust with the hydrocarbon feed in the catalytic partial oxidation reforming reactor.

The hydrogen containing gas stream formed by combustion of the hydrocarbon feed and the oxygen containing gas in the catalytic partial oxidation reforming reactor 30 contains compounds that may be oxidized in the anode 11 of the fuel cell 5 by contact with an oxidant at one or more of the anode electrodes, including hydrogen and carbon monoxide, as well as other compounds such as carbon dioxide. The hydrogen containing gas steam from the catalytic partial oxidation reforming reactor 30 preferably does not contain compounds that may oxidize the one or more anode electrodes in the anode 11 of the fuel cell 5.

The hydrogen containing gas stream formed in the catalytic partial oxidation reforming reactor 30 is hot, and may have a temperature of at least 700° C., or from 700° C. to 1100° C., or from 800° C. to 1000° C. Use of the hot hydrogen gas stream from a catalytic partial oxidation reforming reactor 30 to initiate start up of the solid oxide fuel cell 5 is preferred in the process of the invention since it enables the temperature of the fuel cell 5 to be raised to the operating temperature of the fuel cell 5 almost instantaneously. In an embodiment (not shown), heat may be exchanged in heat exchanger 27 between the hot hydrogen containing gas from the catalytic partial oxidation reforming reactor 30 and an oxygen containing gas fed to the cathode 13 of the fuel cell 5 when initiating operation of the fuel cell 5.

Provided that the hydrogen source 9 is not the catalytic partial oxidation reforming reactor used to initiate operation of the fuel cell 5, upon reaching the operating temperature of the fuel cell 5 the flow of the hot hydrogen containing gas stream from the catalytic partial oxidation reforming reactor 30 into the fuel cell 5 may be shut off by valve 33, while feeding the first gas stream from the hydrogen source 9 into the anode 11 by opening valve 7. Continuous operation of the fuel cell may then conducted according to the process of the invention.

If the hydrogen source 9 is the catalytic partial oxidation reforming reactor used to initiate operation of the fuel cell 5, the hot hydrogen containing gas from the catalytic partial oxidation reforming reactor may be fed to the fuel cell 5 as the first gas stream for continuous operation after the fuel cell 5 has reached its operating temperature. In an embodiment, the hot hydrogen containing gas from the catalytic partial oxidation reactor may be cooled in a heat exchanger as described above and/or hydrogen may be separated from the hot hydrogen containing gas with a high temperature hydrogen separation device prior to being fed to the anode 11 of the fuel cell 5 as the first gas steam for continuous operation of the fuel cell 5.

In another embodiment (not shown in FIG. 1), operation of the fuel cell may be initiated with a hydrogen start-up gas stream from a hydrogen storage tank that may be passed through a start-up heater to bring the fuel cell up to its operating temperature prior to introducing the first gas stream into the fuel cell. The hydrogen storage tank may be operatively connected to the fuel cell to permit introduction of the hydrogen start-up gas stream into the anode of the solid oxide fuel cell. The start-up heater may indirectly heat the hydrogen start-up gas stream to a temperature of from 750° C. to 1000° C. The start-up heater may be an electrical heater or may be a combustion heater. Upon reaching the operating temperature of the fuel cell, the flow of the hydrogen start-up gas stream into the fuel cell may be shut off by a valve, and the first gas stream may be introduced into the fuel cell by opening a valve from the hydrogen generator to the anode of the fuel cell to start the operation of the fuel cell.

Referring again to FIG. 1, during initiation of operation of the fuel cell 5, an oxygen containing gas stream may be introduced into the cathode 13 of the fuel cell 5. The oxygen containing gas stream may be air, oxygen enriched air containing at least 21% oxygen, or pure oxygen. Preferably, the oxygen containing gas stream may be the oxygen containing gas stream that will be fed to the cathode 13 during operation of the fuel cell 5 after initiating operation of the fuel cell.

In a preferred embodiment, the oxygen containing gas stream fed to the cathode 13 of the fuel cell during start-up of the fuel cell has a temperature of at least 500° C., more preferably at least 650° C., and more preferably at least 750° C. The oxygen containing gas stream may be heated by an electric heater before being fed to the cathode 13 of the solid oxide fuel cell 5. In a preferred embodiment, the oxygen containing gas stream used in initiating operation of the fuel cell 5 may be heated by heat exchange with a hot hydrogen containing gas stream from a fuel cell initiating catalytic partial oxidation reforming reaction in heat exchanger 27 prior to being fed to the cathode 13 of the fuel cell 5.

In the process of the invention, during operation of the fuel cell 5 mixing the first and second gas steams and the oxidant at the one or more anode electrodes generates water (as steam) by the oxidation of a portion of hydrogen present in the first and second gas streams fed to the fuel cell with the oxidant. Water generated by oxidation of hydrogen with an oxidant is swept through the anode of the fuel cell by the unreacted portion of the first and second gas streams to exit the anode as part of an anode exhaust stream.

In the process of the present invention, the anode exhaust stream contains a substantial amount of hydrogen. In one aspect of the process of the present invention, the anode exhaust stream may comprise at least 0.6, or at least 0.7, or at least 0.8, or at least 0.9 mole fraction hydrogen. The anode exhaust stream also contains water, and may contain carbon oxides, particularly carbon dioxide and carbon monoxide if the hydrogen generator 9 is a steam reforming reactor or a partial catalytic oxidizing reactor that is not coupled to or integrated with an high temperature hydrogen-separation device.

In the process of the invention, the anode exhaust stream is separated from the fuel cell 5 as it exits the anode exhaust 17. Hydrogen contained in the anode exhaust stream may be separated from the anode exhaust stream to form the second gas stream. The anode exhaust stream exits the solid oxide fuel cell at a high temperature, typically at least 800° C., and must be cooled prior to separating hydrogen in the anode exhaust stream to form the second gas stream. The anode exhaust stream may be cooled by passing the anode exhaust stream from the anode exhaust 17 via line 35 through one or more heat exchangers 37 to cool the anode exhaust stream to a temperature at which hydrogen may be separated from the anode exhaust stream.

In an embodiment, heat may be exchanged between the anode exhaust stream and steam in the one or more heat exchangers 37 to produce high pressure steam. The high pressure steam may be expanded through a turbine (not shown) to drive one or more compressors, one of which may compress the second gas stream before the second gas stream is fed to the fuel cell 5. Alternatively, the high pressure steam may be expanded through a turbine (not shown) to produce electrical power in addition to that produced by the fuel cell 5.

In another embodiment, heat may be exchanged between the anode exhaust stream and one or more streams of water to produce hot water for use in residential housing. This embodiment is particularly useful if the fuel cell 5 is utilized to generate electricity for a residence, or a small group of residences, and is located in close proximity to the residences.

In an embodiment of the process of the present invention, hydrogen may be separated from the cooled anode exhaust stream to form the second gas stream by passing the cooled anode exhaust stream through a hydrogen separation device 39 operatively connected to the anode exhaust 17 through lines 35 and 38 and the one or more heat exchangers 37. In an embodiment, the anode exhaust stream may be cooled to a temperature of from 250° C. to 650° C. and the hydrogen separation device 39 may be a high temperature hydrogen-separation device, such as a palladium coated membrane that is selectively permeable to hydrogen. In another embodiment, anode exhaust stream may be cooled to a temperature of less than 250° C., and the hydrogen separation device 39 may be a low temperature hydrogen-separation device such a pressure swing adsorber.

In an embodiment of the process of the present invention, the anode exhaust stream may be provided to the hydrogen separation device 39 at an elevated pressure, for example, a pressure of at least 0.2 MPa, or at least 0.5 MPa, or at least 1 MPa, or at least 2 MPa to facilitate separation of hydrogen from the anode exhaust. In an embodiment, the hydrogen generator 9 may provide the first gas stream to the fuel cell 5 at a high pressure, and subsequently the anode exhaust stream is provided to the hydrogen separation device 39 at a high pressure, so that hydrogen may be efficiently separated from the anode exhaust stream by a membrane selectively permeable to hydrogen. The first gas stream may be provided to the fuel cell 5 at a high pressure, for example, if the hydrogen generator 9 is a steam reforming reactor or a catalytic partial oxidation reactor that is not operatively coupled to or integrated with a high temperature hydrogen separation device containing a membrane selectively permeable to hydrogen. In another embodiment, the anode exhaust stream may be compressed by a compressor driven by heat exchange with the anode exhaust stream as described above to facilitate separation of hydrogen from the anode exhaust stream by the high temperature hydrogen separation device 39. The high temperature hydrogen separation device 39 may separate hydrogen from hydrocarbons and carbon oxides such as carbon monoxide and carbon dioxide that are present in the anode exhaust stream.

In an embodiment of the process of the invention, the cooled anode exhaust stream may be fed from the one or more heat exchangers 37 via lines 38 and 41 to a condenser 43 to separate the second gas stream from the anode exhaust stream without first being fed to a hydrogen separation device 39, provided the anode exhaust stream consists essentially of hydrogen and water. The anode exhaust stream may consist essentially of hydrogen and water when the hydrogen generator 9 is a hydrogen tank, or a reforming reactor or catalytic partial oxidation reactor operatively connected to or integrated with a high temperature hydrogen separation device such that the first gas stream fed to the fuel cell 5 contains mostly hydrogen and little or no carbon oxides. To separate the second gas stream from the anode exhaust stream in the condenser, the anode exhaust stream may be cooled by the one or more heat exchangers 37 to a low enough temperature for water to condense from the anode exhaust stream in the condenser 43, e.g. lower than 100° C., or lower than 90° C., or lower than 80° C., so that hydrogen may be separated from the condensed water as the second gas stream. Water condensed in the condenser 43 may be removed from the condenser 43 to a water trap 45 through line 47.

In this embodiment, a small portion of the second gas stream formed by separation of hydrogen from water may be passed through a hydrogen separation device 49 as a bleed stream to remove any small amounts of carbon oxides that may be present in the second gas stream as a result of imperfect separation of hydrogen from carbon oxides by a high temperature hydrogen separation device utilized in combination with a reforming reactor or a partial oxidation reactor when producing the first gas stream. Bleed valve 51 and valve 50 may be utilized to control the flow of the bleed stream to the hydrogen separation device 49. In an embodiment, a compressor 53 may be utilized to compress the bleed stream prior to feeding the bleed stream to the hydrogen separation device 49. The compressor 53 may be driven by high temperature steam produced by heat exchange with the anode exhaust stream in the one or more heat exchangers 37 or with the cathode exhaust stream in heat exchanger 27. The hydrogen separation device may be a pressure swing adsorption apparatus or a membrane selectively permeable to hydrogen. Hydrogen separated from the bleed stream by the hydrogen separation device 49 may be fed back to rejoin the second gas stream in line 10 through line 55.

In another embodiment of the process of the invention, the second gas stream separated by the hydrogen separation device 39 may be fed to the condenser 43 via line 41 to separate hydrogen in the second gas stream from steam used to separate the hydrogen from the cooled anode exhaust stream. For example, when the hydrogen separation device 39 separates hydrogen from other compounds in the anode exhaust utilizing a membrane selectively permeable to hydrogen, a steam sweep gas may be used to facilitate the separation of hydrogen by sweeping hydrogen separated by the membrane away from the membrane and out of the hydrogen separation device 39. The hydrogen in the second gas stream may be separated from the steam in the sweep gas by condensing water from the combined second gas stream and sweep gas in the condenser 39. If necessary, the combined second gas stream and steam sweep gas may be cooled to a temperature low enough for water to condense in the condenser 43 by feeding the combined second gas stream and sweep gas through one or more heat exchangers (not shown) after exiting the hydrogen separation device 39 and prior to feeding the combined second gas stream and sweep gas to the condenser 43. Water condensed in the condenser 43 may be removed from the condenser to a water trap 45 through line 47.

In one embodiment of the process of the present invention, water is not condensed either from the anode exhaust stream or from the second gas stream, and a condenser 43 is not utilized in the process. Water need not be condensed from the anode exhaust stream or second gas stream when the second gas stream is separated from the cooled anode exhaust stream by passing the cooled anode exhaust stream through a pressure swing adsorption device 39 effective to separate hydrogen from water as well as other compounds such as carbon oxides.

In an embodiment of the process of the present invention, a portion of hydrogen separated from the anode exhaust stream may be separated from the second gas stream and fed to a hydrogen tank 57. Hydrogen may be fed through metering valve 59 to the hydrogen tank 57. The rate of flow of the second gas stream to the fuel cell 5 may selected and controlled by adjusting valve 59 to regulate the flow of hydrogen to the hydrogen tank 57 as well as the flow of the second gas stream to the fuel cell 5.

The second gas stream—whether produced from the cooled anode exhaust stream by a hydrogen separation device 39 in combination with a condenser 43, a hydrogen separation device 39 alone, or a condenser 43 alone—is fed back to the anode 11 of the solid oxide fuel cell 5 through lines 10 and 1, where the flow rate the second gas stream fed to the anode may be controlled by valve 59 and valve 12. The second gas stream may contain at least 0.8, at least 0.9, at least 0.95, or at least 0.98 mole fraction hydrogen. In an embodiment, the second gas stream may be compressed with compressor 47 to increase the pressure of the second gas stream fed to the anode 11. The pressure of the second gas stream fed to the anode 11 of the fuel cell 5 may be increased to at least 0.15 MPa, or at 0.5 MPa, or at least 1 MPa, or at least 2 MPa, or at least 2.5 MPa. Energy to drive the compressor 47 to compress the second gas stream fed to the anode 11 of the fuel cell 5 may be provided by high pressure steam produced by heat exchange with the anode exhaust stream in the one or more heat exchangers 37, or by heat exchange with the cathode exhaust stream in the heat exchanger 27.

In the process of the invention, where the flow rate of the oxygen containing stream is selected to be sufficient to provide sufficient oxidant to the anode to react with the fuel in the first and second gas streams, the flow rate that the first gas stream is fed to the anode and the flow rate that the second gas stream is fed to the anode 11 may be independently selected so the ratio of amount of water formed in the fuel cell to the amount of hydrogen in the anode exhaust per unit time is at most 1.0, or at most 0.75, or at most 0.67, or at most 0.43, or at most 0.25, or at most 0.11. In an embodiment, the amount of water formed in the fuel cell and the amount of hydrogen in the anode exhaust may be measured in moles so that the ratio of amount of water formed in the fuel cell to the amount of hydrogen in the anode exhaust in moles per unit time is at most 1.0, or at most 0.75, or at most 0.67, or at most 0.43, or at most 0.25, or at most 0.11. In the process of the invention, the flow rate that the first gas stream is fed to the anode and the flow rate that the second gas stream is fed to the anode may be independently selected so the anode exhaust stream contains at least 0.6 mole fraction hydrogen, or at least 0.7 mole fraction hydrogen, or at least 0.8 mole fraction hydrogen, or at least 0.9 mole fraction hydrogen. In the process of the invention, the flow rate that the first gas stream is fed to the anode and the flow rate that the second gas stream is fed to the anode may be independently selected so the anode exhaust stream contains at least 50%, or at least 60%, or at least 70%, or at least 80%, or at least 90% of the hydrogen in the combined first gas stream and the second gas stream fed to the anode. In the process of the present invention, the flow rate that the first gas stream is fed to the anode and the flow rate that the second gas stream is fed to the anode may be independently selected so the per pass hydrogen fuel utilization rate is at most 50%, or at most 40%, or at most 30%, or at most 20%, or at most 10%.

The flow rate that the second gas stream is fed to the anode 11 of the solid oxide fuel cell 5 may be selected by controlling valves 12 and 59 so that the second gas stream is metered to the anode 11 the selected flow rate. The flow rate that the first gas stream is fed to the anode 11 may be selected by controlling metering valve 7 so that the first gas stream is metered to the anode 11 at the selected flow rate. Alternatively, the flow rate that the first gas stream is fed to the anode 11 may be selected by metering the amount of feed fed to the hydrogen generator 9 when a hydrogen generator is used in the process. In an embodiment, an anode exhaust analyzer (not shown) may continuously adjust and independently control valves 12, and 7 and/or 59 so that the first gas stream and the second gas stream are fed to the anode 11 at a desired rate based upon the hydrogen and/or water content of the anode exhaust as measured by the anode exhaust analyzer.

In the process of the invention, the amount of hydrogen in the combined first gas stream and the second gas stream fed to the anode 11 should be sufficient to generate electricity at an electrical power density of at least 0.4 W/cm², or at least 0.5 W/cm², or at least 0.75 W/cm², or at least 1 W/cm², or at least 1.25 W/cm² over the entire anode path length when combined with an oxidant at one or more anode electrodes in the fuel cell 5. In an embodiment, the first gas stream may be selected to contain at least 0.7, or at least 0.8, or at least 0.9, or at least 0.95 mole fraction hydrogen, and at most 0.15, or at most 0.10, or at most 0.05 mole fraction carbon oxides. In an embodiment, the second gas stream may be selected to contain at least 0.85, or at least 0.9, or at least 0.95 mole fraction hydrogen. In an embodiment, the combined first gas stream and the second gas stream fed to the anode 11 may be selected to contain at least 0.8, or at least 0.85, or at least 0.9, or at least 0.95 mole fraction hydrogen.

In the process of the present invention, relatively little carbon dioxide is generated per unit of electricity generated from generation of the first gas stream from the hydrocarbon feed and from oxidation of carbon monoxide to carbon dioxide in the fuel cell. Recycling the hydrogen from the anode exhaust stream in the second gas stream to the fuel cell reduces the amount of hydrogen required to be produced by the hydrogen generator, thereby reducing attendant carbon dioxide by-product production, and reduces the amount of carbon monoxide fed to the fuel cell, if any, potentially reducing the amount of carbon dioxide produced in the fuel cell itself. In the process of the present invention, carbon dioxide is generated at a rate of no more than 400 grams per kilowatt-hour (400 g per kWh) of electricity generated. In a preferred embodiment, carbon dioxide is generated in the process of the present invention at a rate of no more than 350 g per kWh, and in a more preferred embodiment, carbon dioxide is generated in the process of the present invention at a rate of no more than 300 g per kWh.

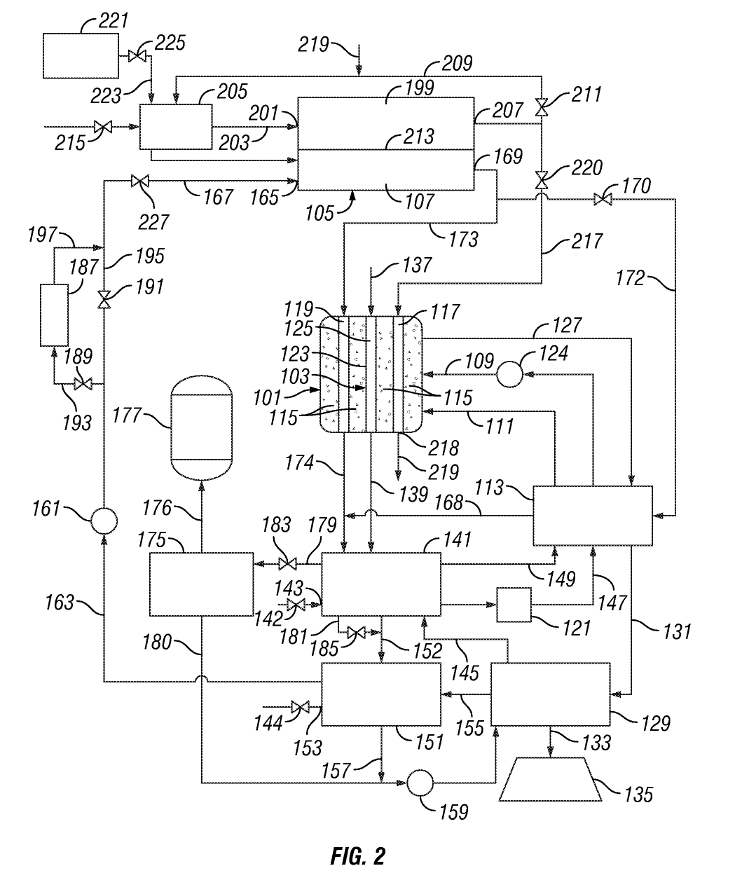

Referring to FIG. 2, in an embodiment the process of the present invention utilizes a system including a thermally integrated hydrogen-separating steam reforming reactor and a solid oxide fuel cell to generate electrical power. A steam reforming reactor 101 including one or more high temperature hydrogen-separating membranes 103 may be operatively coupled to a solid oxide fuel cell 105 to provide a first gas stream containing primarily hydrogen to the anode 107 of the fuel cell 105, while the exhaust from the fuel cell 105 provides the heat to the reforming reactor 101 necessary to drive the reforming and shift reactions in the reactor 101. A second gas stream comprising primarily hydrogen may be separated from the anode exhaust and fed back into the anode 107. The rates that the first and second gas streams are fed to the fuel cell 105 may be selected to produce electricity in the fuel cell 105 at a high electrical power density by flooding the fuel cell 105 with hydrogen to sweep away oxidation products from the electrochemical reaction in the fuel cell.

In an embodiment of the process, a feed comprising a hydrogen source that is a hydrocarbon that is a vapor at a temperature of at most 300° C. under a pressure up to 5 MPa, or up to 4 MPa, or up to 3 MPa (e.g. a gaseous hydrocarbon at temperatures of at least 300° C. at elevated pressure) may be fed to the reforming reactor 101 via line 109. Any (optionally oxygenated) hydrocarbon that is vaporized at a temperature of at most 300° C. at a pressure up to 5 MPa may be used in this embodiment of the process as the feed. Such feeds may include, but are not limited to, methane, methanol, ethane, ethanol, propane, butane, and light hydrocarbons having 1-4 carbon atoms in each molecule. In a preferred embodiment, the feed may be methane or natural gas. Steam may be fed to the reforming reactor 101 via line 111 to be mixed with the feed in a reforming region 115 of the reformer 101.

The feed and the steam may be fed to the reformer 101 at a temperature of from 300° C. to 650° C., where the feed and steam may be heated to the desired temperature in heat exchanger 113 as described below. The feed may be desulfurized in a desulfurizer 121 prior to being heated in the heat exchanger 113, or optionally after being heated in the heat exchanger 113, but before being fed to the reforming reactor 101, to remove sulfur from the feed so the feed does not poison any catalyst in the reforming reactor 101. The feed may be desulfurized in the desulfurizer 121 by contact with a conventional hydrodesulfurizing catalyst.

The feed and steam are fed into a reforming region 115 in the reforming reactor 101. The reforming region 115 may, and preferably does, contain a reforming catalyst therein. The reforming catalyst may be a conventional steam reforming catalyst, and may be any known in the art. Typical steam reforming catalysts which can be used include, but are not limited to, Group VIII transition metals, particularly nickel. It is often desirable to support the reforming catalysts on a refractory substrate (or support). The support, if used, is preferably an inert compound. Suitable inert compounds for use as a support contain elements of Group III and IV of the Periodic Table, such as, for example the oxides or carbides of Al, Si, Ti, Mg, Ce and Zr.

The feed and steam are mixed and contacted with the reforming catalyst in the reforming region 115 of the reforming reactor 101 at a temperature effective to form a reformed product gas containing hydrogen and carbon oxides. The reformed product gas may include compounds formed by steam reforming the hydrocarbons in the feed. The reformed product gas may also include compounds formed by shift reacting carbon monoxide produced by steam reforming with additional steam. The reformed product gas may contain hydrogen and at least one carbon oxide. Carbon oxides that may be in the reformed product gas include carbon monoxide and carbon dioxide.

One or more high temperature tubular hydrogen-separation membranes 103 may be located in the reforming region 115 of the reforming reactor 101 positioned so the reformed product gas may contact the hydrogen-separation membrane(s) 103 and hydrogen may pass through the membrane wall 123 to a hydrogen conduit 125 located within the tubular membrane 103. The membrane wall 123 separates the hydrogen conduit 125 from gaseous communication with non-hydrogen compounds of reformed product gas, feed, and steam in the reforming region 115, and is selectively permeable to hydrogen, elemental and/or molecular, so that hydrogen in the reformed product gas may pass through the membrane wall 123 to the hydrogen conduit 125 while other gases in the reforming region are prevented by the membrane wall 123 from passing to the hydrogen conduit 125.

The high temperature tubular hydrogen-separation membrane(s) 103 in the reforming region may comprise a support coated with a thin layer of a metal or alloy that is selectively permeable to hydrogen. The support may be formed of a ceramic or metallic material that is porous to hydrogen. Porous stainless steel or porous alumina are preferred materials for the support of the membrane 103. The hydrogen selective metal or alloy coated on the support may be selected from metals of Group VIII, including, but not limited to Pd, Pt, Ni, Ag, Ta, V, Y, Nb, Ce, In, Ho, La, Au, and Ru, particularly in the form of alloys. Palladium and platinum alloys are preferred. A particularly preferred membrane 103 used in the present process has a very thin film of a palladium alloy having a high surface area coating a porous stainless steel support. Membranes of this type can be prepared using the methods disclosed in U.S. Pat. No. 6,152,987. Thin films of platinum or platinum alloys having a high surface area would also be suitable as the hydrogen selective material.

The pressure within the reforming region 115 of the reforming reactor 101 is maintained at a level significantly above the pressure within the hydrogen conduit 125 of the tubular membrane 103 so that hydrogen is forced through the membrane wall 123 from the reforming region 115 of the reforming reactor into the hydrogen conduit 125. In an embodiment, the hydrogen conduit 125 is maintained at or near atmospheric pressure, and the reforming region is maintained at a pressure of at least 0.5 MPa, or at least 1.0 MPa, or at least 2 MPa, or at least 3 MPa. The reforming region 115 may be maintained at such elevated pressures by injecting the feed and/or steam at high pressures into the reforming region 115. For example, the feed may comprise high pressure natural gas having a pressure of at least 0.5 MPa, or at least 1.0 MPa, or at least 2.0 MPa, or at least 3.0 MPa that is injected into the reforming region 115. Alternatively, after exiting the heat exchanger 113 the feed and/or steam may be compressed with compressor 124 to a pressure of at least 0.5 MPa, or at least 1.0 MPa, or at least 2.0 MPa, or at least 3.0 MPa then injected into the reforming reactor 101.

The temperature at which the feed and steam are mixed and contacted with the reforming catalyst in the reforming region 115 of the reforming reactor 101 is at least 400° C., and preferably may range from 400° C. to 650° C., most preferably in a range of from 450° C. to 550° C. Unlike typical steam reforming reactions, which produce hydrogen at temperatures in excess of 750° C., the equilibrium of the reforming reaction of the present process is driven towards the production of hydrogen in the reforming reactor 101 operating temperature range of 400° C. to 650° C. since hydrogen is removed from the reforming region 115 into the hydrogen conduit 125 of the hydrogen separation membrane(s) 103. An operating temperature of 400° C. to 650° C. favors the shift reaction as well, converting carbon monoxide and steam to more hydrogen, which is then removed from the reforming region 115 into the hydrogen conduit 125 of the hydrogen separation membrane(s) 103 through the membrane wall member 123 of the membrane(s) 103. The fuel cell 105 exhausts may be used to provide the required heat to induce the reforming and shift reactions in the reforming region 115 of the reforming reactor 101 through the exhaust conduits 117 and 119, as described in further detail below.

A non-hydrogen gaseous stream may be removed from the reforming region 115 via line 127, where the non-hydrogen gaseous stream may include unreacted feed, small amounts of hydrogen not separated from the reformed product gas, and gaseous non-hydrogen reformed products in the reformed product gas. The non-hydrogen reformed products and unreacted feed may include carbon dioxide, water (as steam), and small amounts of carbon monoxide and unreacted hydrocarbons.

In an embodiment, the non-hydrogen gaseous stream separated from the reforming region 115 may be a carbon dioxide gas stream containing at least 0.9, or at least 0.95, or at least 0.98 mole fraction carbon dioxide on a dry basis. The carbon dioxide gas stream may be a high pressure gas stream, having a pressure of at least 1 MPa, or at least 2 MPa, or at least 2.5 MPa. The high pressure carbon dioxide gas stream may contain significant amounts of water as steam as it exits the reforming reactor 101. The water may be removed from the high pressure carbon dioxide gas stream by passing the stream through heat exchanger 113 via line 127 to exchange heat with the steam and feed being fed to the reforming reactor 101, cooling the high pressure carbon dioxide gas stream. The cooled high pressure carbon dioxide gas stream may be cooled further to condense the water from the stream in one or more heat exchangers 129 (shown as one heat exchanger), where the cooled high pressure carbon dioxide stream may be passed to the heat exchanger(s) 129 from heat exchanger 113 via line 131. If there is more than one heat exchanger 129 the heat exchangers 129 may be arranged in series to sequentially cool the high pressure carbon dioxide stream. The dry high pressure carbon dioxide stream may be removed from the (final) heat exchanger 129 via line 133. The condensed water may be fed to condenser 151 through line 155.

The dry high pressure carbon dioxide stream may be expanded through a turbine 135 to drive the turbine 135 and produce a low pressure carbon dioxide stream. Expansion of the dry high pressure carbon dioxide stream thorough the turbine 135 may be used to generate electricity in addition to electricity generated by the fuel cell 105. Alternatively, the turbine 135 may be used to drive a compressor 161, which may be used to compress a gas stream containing hydrogen that is fed to the fuel cell 105 as described below, and/or to drive compressor 124 to compress steam and/or feed being fed to the reforming reactor 101. The low pressure carbon dioxide stream may be sequestered or used for carbonation of beverages.

Alternatively, the high pressure carbon dioxide stream may not be converted to a low pressure carbon dioxide stream, and may be used for enhancing oil recovery from an oil formation by injecting the high pressure carbon dioxide stream into the oil formation.

A first gas stream containing hydrogen may be separated from the reformed product gas in the reforming reactor 101 by selectively passing hydrogen through the membrane wall 123 of the hydrogen separation membrane(s) 103 into the hydrogen conduit 125 of the hydrogen separation membrane(s) 103. The first gas stream may contain a very high concentration of hydrogen, and may contain at least 0.6, or at least 0.7, or at least 0.8, or at least 0.9, or at least 0.95, or at least 0.98 mole fraction hydrogen.

A sweep gas comprising steam may be injected into the hydrogen conduit 125 via line 137 to sweep hydrogen from the inner portion of the membrane wall 123 into the hydrogen conduit 125, thereby increasing the rate hydrogen may be separated from the reforming region 115 by the hydrogen separation membrane 103. The first gas stream and steam sweep gas may be removed from the hydrogen separation membrane 103 and the reforming reactor 101 through hydrogen outlet line 139.

The first gas stream and the steam sweep gas may be fed to a heat exchanger 141 via hydrogen outlet line 139 to cool the first gas stream and steam sweep gas. The combined first gas stream and steam sweep gas may have a temperature of from 400° C. to 650° C., typically a temperature of from 450° C. to 550° C., upon exiting the reforming reactor 101. The combined first gas stream and steam sweep gas may exchange heat with the initial feed and water/steam in the heat exchanger 141. The initial feed may be provided to the heat exchanger 141 via line 143, and water/steam may be provided to the heat exchanger 141 via line 145, where the flow rate of the feed and the water may be regulated by metering valves 142 and 144, respectively. The heated feed and steam may fed to heat exchanger 113 via lines 147 and 149, respectively, for further heating prior to being fed to the reforming reactor 101 as described above. The cooled combined first gas stream and steam sweep gas may be fed to condenser 151 through line 152 to condense water from the combined streams by exchanging heat with water fed into the condenser 151 via line 153 and condensed water separated from the high pressure carbon dioxide gas stream via line 155.

The water condensed in condenser 151 and water fed to the condenser 151 through lines 153 and 155 may be passed through water trap line 157 to a pump 159 which pumps the water to the one or more heat exchangers 129 for heat exchange with the cooled high pressure carbon dioxide gas stream to heat the water while further cooling the cooled high pressure carbon dioxide gas stream. The heated water/steam may be passed to the heat exchanger 141 via line 145, as described above, for further heating to produce steam to be fed to the reforming reactor 101 after further heating in heat exchanger 113.

The cooled first gas stream containing hydrogen and little or no water may be fed from the condenser 151 to a compressor 161 through line 163. The first gas stream may have a pressure at or near atmospheric pressure upon exiting the reforming reactor and being fed through heat exchanger 141 and condenser 151 to the compressor 161. The first gas stream may be compressed in the compressor 161 to increase the pressure of the first gas stream prior to being fed to the fuel cell 105. In an embodiment, the first gas stream may be compressed to a pressure of from 0.15 MPa to 0.5 MPa, and preferably from 0.2 MPa to 0.3 MPa. Energy to drive the compressor 161 may be provided by expansion of the high pressure carbon dioxide stream through a turbine 135 operatively coupled to drive the compressor 161.

The first gas stream may then be fed to the anode 107 of the solid oxide fuel cell 105 through line 167 into the anode inlet 165. The first gas stream provides hydrogen to the anode for electrochemical reaction with an oxidant at one or more anode electrodes along the anode path length in the fuel cell. The rate the first gas stream is fed to the anode 107 of the fuel cell 105 may be selected by selecting the rate that the feed and steam are fed to the reforming reactor 101, which may be controlled by metering valves 142 and 144.

A second gas stream containing hydrogen may also be fed to the anode 107 of the fuel cell 105. The second gas stream is separated from the anode exhaust stream, which contains hydrogen and water. The second gas stream may be separated from the anode exhaust stream by cooling the anode exhaust stream sufficiently to condense water from the anode gas exhaust stream to produce the second gas stream containing hydrogen.

The anode exhaust stream exits the anode 107 through the anode exhaust outlet 169. The anode exhaust stream may be initially cooled by exchanging heat with steam and feed in the reforming reactor. In an embodiment, the anode exhaust stream may be initially cooled by being fed through line 173 to one or more reformer anode exhaust conduits 119 extending into and located within the reforming region 115 of the reforming reactor 105. Heat may be exchanged between the anode exhaust stream and the feed and steam in the reforming region 115 of the reforming reactor 101 as the anode exhaust stream passes through the reforming region 115 in the reformer anode exhaust conduit 119, as described in further detail below, cooling the anode exhaust stream and heating the steam and feed in the reactor 101.

After exchanging heat with the feed and steam in the reforming region 115 of the reforming reactor 101, the cooled anode exhaust stream may exit the anode exhaust conduit 119 through line 174 to heat exchanger 141 where the cooled anode exhaust gas may be cooled further. In one embodiment, to control the flow rate of the second gas stream to the fuel cell 105, at least a portion of the anode exhaust stream may be passed from heat exchanger 141 to a condenser 175 via line 179 to separate hydrogen from water in the selected portion of the anode exhaust stream. Hydrogen may be separated from the selected portion of the anode exhaust stream by condensing water from the anode exhaust stream in the condenser 175. The separated hydrogen may be fed to a hydrogen storage tank 177 through line 176. Water condensed from condenser 175 may be fed to pump 159 through line 180.

Cooled anode exhaust stream not fed to condenser 175 for separation into the hydrogen tank 177 is used to provide the second gas stream to the fuel cell 105 after passing through heat exchanger 141. The cooled anode exhaust stream exiting heat exchanger 141 may be mixed with the first gas stream and steam sweep gas by feeding the cooled anode exhaust stream through line 181 to line 152. The mixture of anode exhaust stream, first gas stream, and steam sweep gas may be then fed to condenser 151 to further cool the anode exhaust stream. The second gas stream, derived from condensing water from the anode exhaust stream, may be separated from the condenser 151 via line 163 mixed together with the first gas stream. The second gas stream may contain at least 0.6, or at least 0.7, or at least 0.8, or at least 0.9, or at least 0.95, or at least 0.98 mole fraction hydrogen, where the hydrogen content of the second gas stream may be determined by determining the hydrogen content of the cooled anode exhaust stream on a dry basis. Water from the anode exhaust stream may be condensed in condenser 151 together with water from the first gas stream and the steam sweep gas, and removed from the condenser 151 through line 157 to be fed to pump 159.

Metering valves 183 and 185 may be used to select the rate of flow rate of the second gas stream to the solid oxide fuel cell 105. The flow rate of the second gas stream to the solid oxide fuel cell may be selected by adjusting valves 183 and 185 in coordination to meter the flow rate of the anode exhaust stream to condenser 151 which regulates the rate of the second gas stream to the solid oxide fuel cell 105. Valve 183 may be completely closed, blocking flow of the anode exhaust stream to condenser 175 and hydrogen to the hydrogen tank 177, and valve 185 may be completely opened to allow the entire anode exhaust stream to flow to the condenser 151 and the second gas stream to flow to the solid oxide fuel cell 105 at a maximum flow rate. In a preferred embodiment, the flow rate of the second gas stream to the fuel cell 105 may be automatically controlled to a selected rate by automatically adjusting the metering valves 183 and 185 in response to the water and/or hydrogen content of the anode exhaust stream.

In an embodiment, a small portion of the combined first and second gas streams may be passed through a hydrogen separation device 187 as a bleed stream to remove any small amounts of carbon oxides that may be present in the first and second gas streams as a result of imperfect separation of hydrogen from carbon oxides by the hydrogen separation membrane 103 in the reforming reactor 101 when producing the first gas stream and its subsequent recycle in the second gas stream. Valves 189 and 191 may be utilized to control the flow of the bleed stream to the hydrogen separation device 187, where preferably valves 189 and 191 may permit a metered flow of the combined first and second gas streams simultaneously through lines 193 and 195, or, alternatively, separately through either line 193 or line 195. The hydrogen separation device 187 is preferably a pressure swing adsorption apparatus effective for separating hydrogen from carbon oxides, or may be a membrane selectively permeable to hydrogen such as those described above. The first and second gas streams in lines 195 and 197 may be combined to be fed to the solid oxide fuel cell 105 through line 167.

In an embodiment of the process, the temperature and pressure of the combined first and second gas streams may be selected for effective operation of the solid oxide fuel cell 105, and, in particular, the temperature should not be so low as to inhibit the electrochemical reactivity of the fuel cell and should not be so high as to induce an uncontrolled exothermic reaction in the fuel cell 105. In an embodiment, the temperature of the combined first and second gas streams may range from 25° C. to 300° C., or from 50° C. to 200° C., or from 75° C. to 150° C. The pressure of the combined first and second streams may be controlled by the compression provided to the combined first and second gas streams by compressor 161, and may be from 0.15 MPa to 0.5 MPa, or from 0.2 MPa to 0.3 MPa.

An oxygen containing gas stream may be fed to the cathode 199 of the fuel cell through cathode inlet 201 via line 203. The oxygen containing gas stream may be provided by an air compressor or an oxygen tank (not shown). In an embodiment, the oxygen containing gas stream may be air or pure oxygen. In another embodiment, the oxygen containing gas stream may be an oxygen enriched air stream containing at least 21% oxygen, where the oxygen enriched air stream provides higher electrical efficiency in the solid oxide fuel cell than air since the oxygen enriched air stream contains more oxygen for conversion into ionic oxygen in the fuel cell.

The oxygen containing gas stream may be heated prior to being fed to the cathode 199 of the fuel cell 105. In one embodiment, the oxygen containing gas stream may be heated to a temperature of from 150° C. to 350° C. prior to being fed to the cathode 199 of the fuel cell 105 in heat exchanger 205 by exchanging heat with a portion of the cathode exhaust provided to the heat exchanger 205 from the cathode exhaust outlet 207 via line 209. The flow rate of the cathode exhaust stream to the heat exchanger 205 may be controlled with metering valve 211. Alternatively, the oxygen containing gas stream may be heated by an electrical heater (not shown), or the oxygen containing gas stream may be provided to the cathode 199 of the fuel cell 105 without heating.

The solid oxide fuel cell 105 used in this embodiment of the process of the invention may be a conventional solid oxide fuel cell, preferably having a planar or tubular configuration, and is comprised of an anode 107, a cathode 199, and an electrolyte 213 where the electrolyte 213 is interposed between the anode 107 and the cathode 199. The solid oxide fuel cell may be comprised of a plurality of individual fuel cells stacked together—joined electrically by interconnects and operatively connected so that a fuel may flow through the anodes of the stacked fuel cells and an oxygen containing gas may flow through the cathodes of the stacked fuel cells. As used herein, the term “solid oxide fuel cell” is defined as either a single solid oxide fuel cell or a plurality of operatively connected or stacked solid oxide fuel cells. In an embodiment, the anode 107 is formed of a Ni/ZrO₂ cermet, the cathode 199 is formed of a doped lanthanum manganite or stabilized ZrO₂ impregnated with praseodymium oxide and covered with SnO doped In₂O₃, and the electrolyte 213 is formed of yttria stabilized ZrO₂ (approximately 8 mol % Y₂O₃). The interconnect between stacked individual fuel cells or tubular fuel cells may be a doped lanthanum chromite.

The solid oxide fuel cell 105 is configured so that the first and second gas streams may flow through the anode 107 of the fuel cell 105 from the anode inlet 165 to the anode exhaust outlet 169, contacting one or more anode electrodes over the anode path length from the anode inlet 165 to the anode exhaust outlet 169. The fuel cell 105 is also configured so that the oxygen containing gas may flow through the cathode 199 from the cathode inlet 201 to the cathode exhaust outlet 207, contacting one or more cathode electrodes over the cathode path length from the cathode inlet 201 to the cathode exhaust outlet 207. The electrolyte 213 is positioned in the fuel cell 105 to prevent the first and second gas streams from entering the cathode and to prevent the oxygen containing gas from entering the anode, and to conduct ionic oxygen from the cathode to the anode for electrochemical reaction with hydrogen in the first and second gas streams at the one or more anode electrodes.

The solid oxide fuel cell 105 is operated at a temperature effective to enable ionic oxygen to traverse the electrolyte 213 from the cathode 199 to the anode 107 of the fuel cell 105. The solid oxide fuel cell 105 may be operated at a temperature of from 700° C. to 1100° C., or from 800° C. to 1000° C. The oxidation of hydrogen with ionic oxygen at the one or more anode electrodes is a very exothermic reaction, and the heat of reaction generates the heat required to operate the solid oxide fuel cell 105. The temperature at which the solid oxide fuel cell is operated may be controlled by independently controlling the temperature of the first gas stream, the temperature of the second gas stream, and the temperature of the oxygen containing gas stream, and the flow rates that these streams are fed to the fuel cell 105. In an embodiment, the temperature of the second gas stream fed to the fuel cell is controlled to a temperature of at most 100° C., the temperature of the oxygen containing gas stream is controlled to a temperature of at most 300° C., and the temperature of the first gas stream is controlled to a temperature of at most 550° C. to maintain the operating temperature of the solid oxide fuel cell in a range from 700° C. to 1100° C., and preferably in a range of from 800° C. to 900° C.

To initiate operation of the fuel cell 105, the fuel cell 105 is heated to its operating temperature. In a preferred embodiment, operation of the solid oxide fuel cell 105 may be initiated by generating a hydrogen containing gas stream in a catalytic partial oxidation reforming reactor 221 and feeding the hydrogen containing gas stream through line 223 to the anode 107 of the solid oxide fuel cell. A hydrogen containing gas stream may be generated in the catalytic partial oxidation reforming reactor by combusting a hydrocarbon feed and an oxygen source in the catalytic partial oxidation reforming reactor 221 in the presence of a conventional partial oxidation reforming catalyst, where the oxygen source is fed to the catalytic partial oxidation reforming reactor in a substoichiometric amount relative to the hydrocarbon feed.

The hydrocarbon feed fed to the catalytic partial oxidation reforming reactor 221 may be a liquid or gaseous hydrocarbon or mixtures of hydrocarbons, and preferably is methane, natural gas, or other low molecular weight hydrocarbon or mixture of low molecular weight hydrocarbons. In a particularly preferred embodiment of the process of the invention, the hydrocarbon feed fed to the catalytic partial oxidation reforming reactor 221 may be a feed of the same type as used in the reforming reactor 101 to reduce the number of hydrocarbon feeds required run the process.

The oxygen containing feed fed to the catalytic partial oxidation reforming reactor 221 may be pure oxygen, air, or oxygen enriched air. The oxygen containing feed should be fed to the catalytic partial oxidation reforming reactor 221 in substoichiometric amounts relative to the hydrocarbon feed to combust with the hydrocarbon feed in the catalytic partial oxidation reforming reactor 221.

The hydrogen containing gas stream formed by combustion of the hydrocarbon feed and the oxygen containing gas in the catalytic partial oxidation reforming reactor 221 contains compounds that may be oxidized in the anode 107 of the fuel cell 105 by contact with an oxidant at one or more of the anode electrodes, including hydrogen and carbon monoxide, as well as other compounds such as carbon dioxide. The hydrogen containing gas steam from the catalyst partial oxidation reforming reactor 221 preferably does not contain compounds that may oxidize the one or more anode electrodes in the anode 107 of the fuel cell 105.

The hydrogen containing gas stream formed in the catalytic partial oxidation reforming reactor 221 is hot, and may have a temperature of at least 700° C., or from 700° C. to 1100° C., or from 800° C. to 1000° C. Use of the hot hydrogen containing gas stream from the catalytic partial oxidation reforming reactor 221 to initiate start up of the solid oxide fuel cell 105 is preferred in the process of the invention since it enables the temperature of the fuel cell 105 to be raised to the operating temperature of the fuel cell 105 almost instantaneously. In an embodiment, heat may be exchanged in heat exchanger 205 between the hot hydrogen containing gas from the catalytic partial oxidation reforming reactor and an oxygen containing gas fed to the cathode 199 of the fuel cell 105 when initiating operation of the fuel cell 105 to heat the oxygen containing gas.

Upon reaching the operating temperature of the fuel cell 105, the flow of the hot hydrogen containing gas stream from the catalytic partial oxidation reforming reactor 221 into the fuel cell 105 may be shut off by valve 225, while feeding the first gas stream from the reforming reactor 101 into the anode 107 by opening valve 227. Continuous operation of the fuel cell may then conducted according to the process of the invention.

In another embodiment (not shown in FIG. 2), operation of the fuel cell may be initiated with a hydrogen start-up gas stream from the hydrogen storage tank 177, where the hydrogen start-up gas stream is passed through a start-up heater to bring the fuel cell up to its operating temperature prior to introducing the first gas stream into the fuel cell. The hydrogen storage tank 177 may be operatively connected to the fuel cell to permit introduction of the hydrogen start-up gas stream into the anode of the solid oxide fuel cell. The start-up heater may indirectly heat the hydrogen start-up gas stream to a temperature of from 750° C. to 1000° C. The start-up heater may be an electrical heater or may be a combustion heater. Upon reaching the operating temperature of the fuel cell, the flow of the hydrogen start-up gas stream into the fuel cell may be shut off by a valve, and the first gas stream and the oxygen containing gas stream may be introduced into the fuel cell to start the operation of the fuel cell.

Referring again to FIG. 2, during initiation of operation of the fuel cell 105, an oxygen containing gas stream may be introduced into the cathode 199 of the fuel cell 105. The oxygen containing gas stream may be air, oxygen enriched air containing at least 21% oxygen, or pure oxygen. Preferably, the oxygen containing gas stream is the oxygen containing gas stream that will be fed to the cathode 199 during operation of the fuel cell 105 after initiating operation of the fuel cell.

In a preferred embodiment, the oxygen containing gas stream fed to the cathode 199 of the fuel cell during start-up of the fuel cell has a temperature of at least 500° C., more preferably at least 650° C., and more preferably at least 750° C. The oxygen containing gas stream may be heated by an electric heater before being fed to the cathode 199 of the solid oxide fuel cell 105. In a preferred embodiment, the oxygen containing gas stream used in initiating operation of the fuel cell 105 may be heated by heat exchange with the hot hydrogen containing gas stream from a catalytic partial oxidation reforming reaction in heat exchanger 205 prior to being fed to the cathode 199 of the fuel cell 105.

Once operation of the fuel cell 105 has commenced, the first and second gas streams may be mixed with an ionic oxygen oxidant at one or more anode electrodes in the fuel cell 105 to generate electricity. The ionic oxygen oxidant is derived from oxygen in the oxygen-containing gas stream flowing through the cathode 199 of the fuel cell 105 and conducted across the electrolyte 213 of the fuel cell. The first and second gas streams fed to the anode 107 of the fuel cell 105 and the oxidant are mixed in the anode 107 at the one or more anode electrodes of the fuel cell 105 by feeding the first gas stream, the second gas stream, and the oxygen containing gas stream to the fuel cell 105 at selected independent rates while operating the fuel cell at a temperature of from 750° C. to 1100° C.

The first and second gas streams and the oxidant are preferably mixed at the one or more anode electrodes of the fuel cell 105 to generate electricity at an electrical power density of at least 0.4 W/cm², more preferably at least 0.5 W/cm², or at least 0.75 W/cm², or at least 1 W/cm², or at least 1.25 W/cm², or at least 1.5 W/cm². Electricity may be generated at such electrical power densities by independently selecting and controlling the flow rates of the first gas stream and the second gas stream to the anode 107 of the fuel cell 105. The flow rate of the first gas stream to the anode 107 of the fuel cell 105 may be selected and controlled by selecting and controlling the rate that the feed and steam are fed to the reforming reactor by adjusting metering valves 142 and 144. The flow rate of the second gas stream to the anode 107 of the fuel cell 105 may be selected and controlled by selecting and controlling the flow rate of the anode exhaust stream to the condenser 151 by adjusting metering valves 183 and 185 as described above. In an embodiment, metering valves 183 and 185 may be automatically adjusted by a feedback circuit (not shown) that measures water and/or hydrogen content in the anode exhaust stream to select the rate the second gas stream is fed to the fuel cell 105, and adjusts the metering valves 183 and 185 to maintain a selected water and/or hydrogen content in the anode exhaust stream by adjusting the rate the second gas stream is fed to the fuel cell 105.

In the process of the invention, mixing the first and second gas streams and the oxidant at the one or more anode electrodes generates water (as steam) by the oxidation of a portion of hydrogen present in the first and second gas streams fed to the fuel cell 105 with the oxidant. Water generated by the oxidation of hydrogen with an oxidant is swept through the anode 107 of the fuel cell 105 by the unreacted portion of the first and second gas streams to exit the anode 107 as part of the anode exhaust stream.

In an embodiment of the process of the invention, the flow rate that the first gas stream is fed to the anode 107 and the flow rate that the second gas stream is fed to the anode 107 may be independently selected so the ratio of amount of water formed in the fuel cell per unit of time to the amount of hydrogen in the anode exhaust per unit of time is at most 1.0, or at most 0.75, or at most 0.67, or at most 0.43, or at most 0.25, or at most 0.11. In an embodiment, the amount of water formed in the fuel cell and the amount of hydrogen in the anode exhaust may be measured in moles so that the ratio of the amount of water formed in the fuel cell per unit of time to the amount of hydrogen in the anode exhaust per unit of time in moles per unit of time is at most 1.0, or at most 0.75, or at most 0.67, or at most 0.43, or at most 0.25, or at most 0.11. In another embodiment of the process of the invention, the flow rate that the first gas stream is fed to the anode 107 and the flow rate that the second gas stream is fed to the anode 107 may be independently selected so the anode exhaust stream contains at least 0.6, or at least 0.7, or at least 0.8, or at least 0.9 mole fraction hydrogen. In an embodiment, the flow rate that the first gas stream is fed to the anode 107 and the flow rate that the second gas stream is fed to the anode 107 may be independently selected so the anode exhaust stream contains at least 50%, or at least 60%, or at least 70%, or at least 80%, or at least 90% of the hydrogen in the combined first and second gas streams fed to the anode 107. In an embodiment, the flow rate that the first gas stream is fed to the anode 107 and the flow rate that the second gas stream is fed to the anode 107 may be independently selected so that per pass hydrogen utilization of the fuel cell is at most 50%, or at most 40%, or at most 30%, or at most 20%, or at most 10%.

The flow rate of the oxygen containing gas stream provided to the cathode 199 of the solid oxide fuel cell 105 should be selected to provide sufficient oxidant to the anode to generate electricity at an electrical power density of at least 0.4 W/cm², or at least 0.5 W/cm², or at least 0.75 W/cm², or at least 1 W/cm², or at least 1.25 W/cm², or at least 1.5 W/cm² when combined with the fuel from the first and second gas streams at the one or more anode electrodes. The flow rate of the oxygen containing gas stream to the cathode 199 may be selected and controlled by adjusting metering valve 215.

The reforming reactor 101 and the solid oxide fuel cell 105 may be thermally integrated so the heat from the exothermic electrochemical reaction in the fuel cell 105 is provided to the reforming region 115 of the reforming reactor 101 to drive the endothermic reforming reaction in the reforming reactor 101. As described above, one or more anode exhaust conduits 119 and one or more cathode exhaust conduits 117 may extend into and may be located within the reforming region 115 of the reforming reactor 101. A hot anode exhaust stream may exit the anode 107 of the fuel cell 105 from the anode exhaust outlet 169 and enter the anode exhaust conduit 119 in the reforming region 115 via line 173, and/or a hot cathode exhaust stream may exit the cathode 199 of the fuel cell 105 from the cathode exhaust outlet 207 and enter the cathode exhaust conduit 117 in the reforming region 115 via line 217. Heat from the hot anode exhaust stream may be exchanged between the anode exhaust stream and the mixture of steam and feed in the reforming region 115 as the anode exhaust stream passes through the anode exhaust conduit 119. Likewise, heat from the hot cathode exhaust stream may be exchanged between the cathode exhaust stream and the mixture of steam and feed in the reforming region 115 of the reforming reactor 101 as the cathode exhaust stream passes through the cathode exhaust conduit 117.

The heat exchange from the exothermic solid oxide fuel cell 105 to the endothermic reforming reactor 101 is highly efficient. Location of the anode exhaust conduit(s) 119 and/or the cathode exhaust conduit(s) 117 within the reforming region 115 of the reforming reactor 101 permits exchange of heat between the hot anode and/or cathode exhaust streams and the mixture of feed and steam within the reactor 101, transferring heat to the feed and steam at the location that the reforming reaction takes place. Further, location of the anode and/or cathode exhaust conduits 119 and 117 within the reforming region 115 permits the hot anode and/or cathode exhaust streams to heat the reforming catalyst in the reforming region 115 as a result of the close proximity of the conduits 117 and 119 to the catalyst bed.

Further, no additional heat other than provided by either 1) the anode exhaust stream; or 2) the cathode exhaust stream; or 3) the anode exhaust stream in combination with the cathode exhaust stream, needs to be provided to the reforming reactor 101 to drive the reforming and shift reactions in the reactor 101 to produce the reformed product gas and the first gas stream. As noted above, the temperature required to run the reforming and shift reactions within the reforming reactor 101 is from 400° C. to 650° C., which is much lower than conventional reforming reactor temperatures—which are at least 750° C., and typically 800° C.-900° C. The reforming reactor may be run at such low temperatures due to the equilibrium shift in the reforming reaction engendered by separation of hydrogen from the reforming reactor 101 by the high temperature hydrogen separation membrane 103. The anode exhaust stream and the cathode exhaust stream may each have a temperature of from 800° C. to 1000° C., which, upon heat exchange between the mixture of feed and steam and the anode exhaust stream, or the cathode exhaust stream, or both the anode and cathode exhaust streams is sufficient to drive the lower temperature reforming and shift reactions in the reforming reactor 101.

In an embodiment of the process of the invention, the exchange of heat between the anode exhaust stream and the mixture of steam and feed in the reforming region 115 as the anode exhaust stream passes through the anode exhaust conduit 119 may provide a significant amount of the heat provided to the mixture of steam and feed in the reactor 101 to drive the reforming and shift reactions. In an embodiment of the process of the invention, the exchange of heat between the anode exhaust stream and the mixture of steam and feed in the reactor 101 may provide at least 40%, or at least 50%, or at least 70%, or at least 90% of the heat provided to the mixture of steam and feed in the reactor 101. In an embodiment, the heat supplied to the mixture of steam and feed in the reforming reactor 101 consists essentially of the heat exchanged between the anode exhaust stream passing through the anode exhaust conduit 119 and the mixture of steam and feed in the reforming reactor 101. In an embodiment of the process, the exchange of heat between the anode exhaust stream and the mixture of steam and feed in the reactor 101 may be controlled to maintain the temperature of the mixture of steam and feed in a range of from 400° C. to 650° C.

In an embodiment of the process of the invention, the exchange of heat between the cathode exhaust stream and the mixture of steam and feed in the reforming region 115 as the cathode exhaust stream passes through the cathode exhaust conduit 117 may provide a significant amount of the heat provided to the mixture of steam and feed in the reactor 101 to drive the reforming and shift reactions. In an embodiment of the process of the invention, the exchange of heat between the cathode exhaust stream and the mixture of steam and feed in the reactor 101 may provide at least 40%, or at least 50%, or at least 70%, or at least 90% of the heat provided to the mixture of steam and feed in the reactor 101. In an embodiment, the heat supplied to the mixture of steam and feed in the reforming reactor 101 consists essentially of the heat exchanged between the cathode exhaust stream passing through the cathode exhaust conduit 117 and the mixture of steam and feed in the reforming reactor 101. In an embodiment of the process, the exchange of heat between the cathode exhaust stream and the mixture of steam and feed in the reactor 101 may be controlled to maintain the temperature of the mixture of steam and feed in a range of from 400° C. to 650° C.

In an embodiment, the exchange of heat between the anode exhaust stream, the cathode exhaust stream, and the mixture of steam and feed in the reforming region 115 as the anode exhaust stream passes through the anode exhaust conduit 119 and the cathode exhaust stream passes through the cathode exhaust conduit 117 may provide a significant amount of the heat provided to the mixture of steam and feed in the reactor 101 to drive the reforming and shift reactions. In an embodiment of the process of the invention, the exchange of heat between the cathode exhaust stream and the mixture of steam and feed in the reactor 101 may provide up to 60%, or up to 50%, or up to 40%, or up to 30%, or up to 20% of the heat provided to the mixture of steam and feed in the reactor 101 while the anode exhaust stream may provide at least 40%, or at least 50%, or at least 60%, or at least 70%, or at least 80% of the heat provided to the mixture of steam and feed in the reactor 101. In an embodiment, the heat supplied to the mixture of steam and feed in the reforming reactor 101 may consist essentially of heat exchanged between the anode and cathode exhaust streams and the mixture of steam and feed in the reactor 101. In an embodiment of the process, the exchange of heat between the anode and cathode exhaust streams and the mixture of steam and feed in the reactor 101 may be controlled to maintain the temperature of the mixture of steam and feed in a range of from 400° C. to 650° C.

In a preferred embodiment, the heat provided by the anode exhaust stream, or the cathode exhaust stream, or the anode and cathode exhaust streams to the mixture of steam and feed in the reforming reactor 101 is sufficient to drive the reforming and shift reactions in the reforming reactor 101 such that no other source of heat is required to drive the reactions in the reforming reactor 101. Preferably, no heat is provided to the mixture of steam and feed in the reactor 101 by combustion or electrical heating.

In an embodiment, the anode exhaust stream provides most, or substantially all, of the heat to the mixture of steam and feed in the reforming reactor 101 to drive the reforming and shift reactions in the reactor 101 as the anode exhaust stream passes through the reforming region 115 in the anode exhaust conduit 119. In this embodiment only some, or none, of the cathode exhaust stream is required to exchange heat with the mixture of steam and feed in the reforming reactor 101 to drive the reforming and shift reactions. The flow of the cathode exhaust stream through the cathode exhaust conduit 117 in the reforming reactor may be controlled to control the amount of heat provided to the mixture of steam and feed in the reforming reactor 101 from the cathode exhaust stream. Metering valves 211 and 220 may be adjusted to control the flow of the cathode exhaust stream to the cathode exhaust conduit 117 such that the cathode exhaust stream provides the desired amount of heat, if any, to the mixture of steam and feed in the reactor 101. Cathode exhaust stream that is not required to heat the mixture of steam and feed in the reactor 101 may be shunted through line 209 to heat exchanger 205 to heat the oxygen containing gas fed to the cathode.

In an embodiment, the cathode exhaust stream provides most, or all, of the heat to the mixture of steam and feed in the reforming reactor 101 to drive the reforming and shift reactions in the reactor. In this embodiment only some, or none, of the anode exhaust stream is required to exchange heat with the mixture of steam and feed in the reforming reactor 101 to drive the reforming and shift reactions. The flow of the anode exhaust stream through the anode exhaust conduit 119 in the reforming reactor may be controlled to control the amount of heat provided to the mixture of steam and feed in the reforming reactor 101 from the anode exhaust stream. The portion of the anode exhaust stream not used to provide heat to the reforming reactor 101 may be fed via line 172 through heat exchanger 113 to heat the feed and steam entering the reforming reactor 101 and cool the anode exhaust stream prior to being combined via line 168 with the first gas stream and steam sweep gas in line 174 for further cooling in heat exchanger 141. The flow of the anode exhaust stream through heat exchanger 113 may be controlled by metering valve 170.

Cooled cathode exhaust stream that has passed through the cathode exhaust conduit 117 may still have a significant amount of heat therein, and may have a temperature of up to 650° C. The cooled cathode exhaust stream may be passed out of the cathode exhaust conduit through outlet 218 to be fed to the oxygen containing gas heat exchanger 205 through line 219 along with any cathode exhaust stream metered to the heat exchanger 205 through valve 211.

In this embodiment of the process of the present invention, relatively little carbon dioxide may be generated per unit of electricity produced by the process, in particular, from generation of the first gas stream from the hydrocarbon feed 105. First recycling the hydrogen from the anode exhaust stream in the second gas stream to the fuel cell 105 reduces the amount of hydrogen required to be produced by the reforming reactor 101, thereby reducing attendant carbon dioxide by-product production. Second, the thermal integration of the reforming reactor 101 with the fuel cell 105—wherein the heat produced in the fuel cell 105 is transferred within the reforming reactor 101 by the anode and/or cathode exhausts from the fuel cell 105—reduces the energy required to be provided to drive the endothermic reforming reaction, reducing the need to provide such energy, for example by combustion, thereby reducing the amount of carbon dioxide produced in providing energy to drive the reforming reaction.

In this embodiment of the process of the present invention, carbon dioxide may be generated at a rate of no more than 400 grams per kilowatt-hour (400 g per kWh) of electricity generated. In a preferred embodiment, carbon dioxide is generated in the process of the present invention at a rate of no more than 350 g per kWh, and in a more preferred embodiment, carbon dioxide is generated in the process of the present invention at a rate of no more than 300 g per kWh.

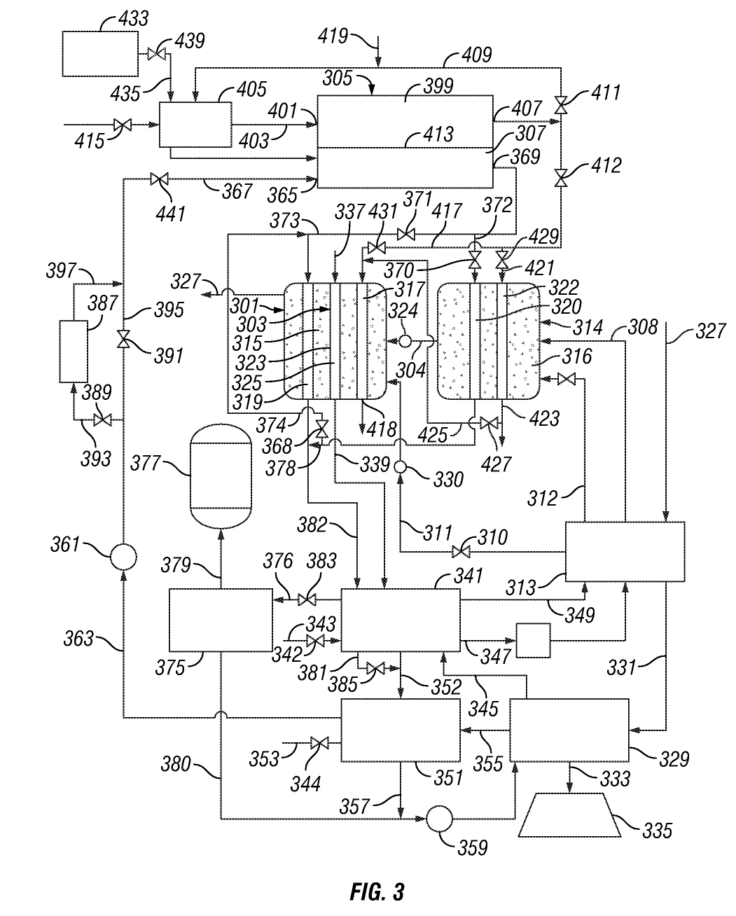

In another embodiment, as shown in FIG. 3, the process of the present invention may use a liquid hydrocarbon feed precursor that may be hydrocracked, and in an embodiment partially reformed, to a gaseous hydrocarbon feed in a pre-reforming reactor 314 which may then be reformed in a hydrogen-separating steam reforming reactor 301 to produce hydrogen which may be utilized to generate electricity in a solid oxide fuel cell 305. The process is thermally integrated, where heat to drive the endothermic pre-reforming reactor 314 and reforming reactor 301 may be provided from the exothermic solid oxide fuel cell 305 directly within the pre-reforming reactor 314 and/or the reforming reactor 301.

A steam reforming reactor 301 including one or more high temperature hydrogen-separating membranes 303 is operatively coupled to a solid oxide fuel cell 305 to provide a first gas stream containing primarily hydrogen to the anode 307 of the fuel cell 305 so that electricity may be generated in the fuel cell 305. A pre-reforming reactor 314 is operatively coupled to the steam reforming reactor 301 to provide a gaseous hydrocarbon feed to the reforming reactor 301 from a liquid hydrocarbon feed. The fuel cell 305 is operatively coupled to the reforming reactor 301 and the pre-reforming reactor 314 so the fuel cell 305 may provide the heat to the reforming reactor 301 necessary to drive the reforming and shift reactions in the reactor 301 and may provide the heat to the pre-reforming reactor 314 necessary to convert a liquid hydrocarbon feed precursor into a gaseous hydrocarbon feed that may be reformed in the reforming reactor 301.

In this process, a feed precursor comprising a hydrogen source that contains a liquid hydrocarbon may be fed to the pre-reforming reactor 314 via line 308. The feed precursor may contain one or more of any vaporizable hydrocarbon that is liquid at 20° C. at atmospheric pressure (optionally oxygenated) that is vaporizable at temperatures up to 400° C. at atmospheric pressure. Such feed precursors may include, but are not limited to, light petroleum fractions such as naphtha, diesel, and kerosene having boiling point range of 50-205° C. The feed precursor may optionally contain some hydrocarbons that are gaseous at 25° C. such as methane, ethane, propane, or other compounds containing from one to four carbon atoms that are gaseous at 25° C. In a preferred embodiment, the feed precursor may be diesel fuel. Steam may be fed to the pre-reforming reactor 314 via line 312 to be mixed with the feed precursor in a pre-reforming region 316 of the pre-reforming reactor 314.

The feed precursor and the steam may be fed to the pre-reforming reactor 314 at a temperature of from 250° C. to 650° C., where the feed precursor and steam may be heated to the desired temperature in heat exchanger 313 as described below. The feed precursor may be hydrocracked and vaporized to form the gaseous hydrocarbon feed in the pre-reforming reactor 314 as described more fully below. In an embodiment the feed precursor may be partially reformed as it is hydrocracked and vaporized to form the gaseous hydrocarbon feed. Feed and steam from the pre-reforming reactor 314 may be fed to the reforming reactor 301 at a temperature of from 300° C. to 650° C.

The feed precursor may be desulfurized in a desulfurizer 321 prior to being heated in the heat exchanger 313, or optionally after being heated in the heat exchanger 313, but before being fed to the pre-reforming reactor 314, to remove sulfur from the feed precursor so the feed precursor does not poison any catalyst in the pre-reforming reactor 314. The feed precursor may be desulfurized in the desulfurizer 321 by contact with a conventional hydrodesulfurizing catalyst under conventional desulfurizing conditions.

The feed precursor and steam are fed into a pre-reforming region 316 in the pre-reforming reactor 314. The pre-reforming region 316 may, and preferably does, contain a pre-reforming catalyst therein. The pre-reforming catalyst may be a conventional pre-reforming catalyst, and may be any known in the art. Typical pre-reforming catalysts which can be used include, but are not limited to, Group VIII transition metals, particularly nickel and a support or substrate that is inert under high temperature reaction conditions. Suitable inert compounds for use as a support for the high temperature pre-reforming/hydrocracking catalyst include, but are not limited to, α-alumina and zirconia.

The feed precursor and steam are mixed and contacted with the pre-reforming catalyst in the pre-reforming region 316 of the pre-reforming reactor 314 at a temperature effective to vaporize the feed precursor to form the feed. Mixing and contacting the feed precursor and steam in the pre-reforming reactor 314 with a pre-reforming catalyst at a temperature effective to vaporize the feed precursor may crack hydrocarbons in the feed precursor to reduce the carbon chain length of the hydrocarbons so that the cracked hydrocarbons may be easily steam reformed in the reforming reactor 301. In an embodiment, the feed precursor and steam are mixed and contacted with the pre-reforming catalyst at a temperature of at least 600° C., or from 700° C. to 1000° C., or from 700° C. to 900° C.; and at a pressure of from 0.1 MPa to 3 MPa, preferably from 0.1 MPa to 1 MPa, or from 0.2 MPa to 0.5 MPa. As discussed below, heat is supplied to drive the endothermic pre-reforming reaction from the anode exhaust stream and/or from the cathode exhaust stream of the fuel cell 305 through one or more pre-reformer anode exhaust conduits 320 and/or one or more pre-reformer cathode exhaust conduits 322, respectively, extending into and located within the pre-reforming region 316 of the pre-reforming reactor 314.

In an embodiment, an excess of steam may be fed to the pre-reforming reactor 314 relative to the amount of hydrocarbons fed to the pre-reforming reactor 314 in the feed precursor. The excess steam may prevent the pre-reforming catalyst from being coked during the pre-reforming reaction. The excess steam may also be fed to the steam reforming reactor 301 from the pre-reforming reactor 314 along with the feed produced in the pre-reforming reactor, where the steam fed to the reforming reactor 301 may be used in the reforming reactor 301 in the reforming reactions and shift reactions in the reforming reactor 301. The ratio of amount of steam fed to the pre-reforming reactor relative to the amount of feed precursor, in volume or in moles, may be at least 2:1 or at least 3:1, or at least 4:1, or at least 5:1.

The feed precursor vaporized, optionally cracked, and optionally partially reformed in the pre-reforming reactor 314 forms the feed that may be fed to the reforming reactor 301. The temperature and pressure conditions in the pre-reforming region 316 of the pre-reforming reactor 314 may be selected so the feed formed in the pre-reforming reactor 314 contains primarily light hydrocarbons that are gaseous at 25° C., typically containing from one to four carbons in each molecule. The feed formed in the pre-reforming reactor may include, but is not limited to, methane, methanol, ethane, ethanol, propane, and butane. Preferably, the temperature and pressure of the pre-reforming reactor are controlled to produce a feed containing at least 50 vol. %, or at least 60 vol. %, or at least 80 vol. % methane on a dry basis. In an embodiment, when the pre-reforming reactor 314 at least partially reforms the feed precursor, the feed fed from the pre-reforming reactor 314 to the reforming reactor 301 may contain hydrogen and carbon monoxide.

Upon formation of the feed in the pre-reforming reactor 314, the feed and the remaining steam may be fed from the pre-reforming reactor 314 to the reforming reactor 301 via line 309 at a temperature of from 350° C. to 650° C., where the feed and steam carry the heat from the pre-reforming reactor 314 into the reforming reactor 301. The mixture of feed and steam from the pre-reforming reactor 314 may be compressed with compressor 324 prior to being fed to the reforming reactor 301 so the pressure within the reforming reactor 301 is such that hydrogen produced in the reforming reactor 301 may be separated from the reforming reactor 301 through a high temperature hydrogen-separation membrane 303 located in the reforming reactor 301. The mixture of feed and steam may be compressed to a pressure of at least 0.5 MPa, or at least 1 MPa, or at least 2 MPa, or at least 3 MPa.

If necessary, additional steam may be fed into the reforming region 315 of the reforming reactor 301 from steam heated in heat exchanger 313. The additional steam may be fed from heat exchanger 313 to the reforming reactor 301 through line 311. Metering valve 310 may be used to regulate the amount of steam fed from heat exchanger 313 to the reforming reactor 301. Compressor 330 may be used to compress the steam to the pressure that the mixture of feed and steam are being fed to the reforming reactor 301 from the pre-reforming reactor 314 and compressor 324.

The mixture of feed and steam from the pre-reforming reactor 314, and optionally additional steam from heat exchanger 313, may be fed into a reforming region 315 in the reforming reactor 301. The reforming region 315 may, and preferably does, contain a reforming catalyst therein. The reforming catalyst may be a conventional steam reforming catalyst, and may be any known in the art. Typical steam reforming catalysts which can be used include, but are not limited to, Group VIII transition metals, particularly nickel. It is often desirable to support the reforming catalysts on a refractory substrate (or support). The support, if used, is preferably an inert compound. Suitable inert compounds for use as a support contain elements of Group III and IV of the Periodic Table, such as, for example the oxides or carbides of Al, Si, Ti, Mg, Ce and Zr.

The feed and steam are mixed and contacted with the reforming catalyst in the reforming region 315 at a temperature effective to form a reformed product gas containing hydrogen and carbon oxides. The reformed product gas may be formed by steam reforming the hydrocarbons in the feed. The reformed product gas may also be formed by shift reacting carbon monoxide in the feed and/or produced by steam reforming with additional steam. The reformed product gas may contain hydrogen and at least one carbon oxide. Carbon oxides that may be in the reformed product gas include carbon monoxide and carbon dioxide.

In an embodiment of the process of the present invention, one or more high temperature tubular hydrogen-separation membranes 303 may be located in the reforming region 315 of the reforming reactor 301 positioned so the reformed product gas may contact the hydrogen-separation membrane(s) 303 and hydrogen may pass through the membrane wall 323 to a hydrogen conduit 325 located within the tubular membrane 303. The membrane wall 323 separates the hydrogen conduit 325 from gaseous communication with non-hydrogen compounds of reformed product gas, feed, and steam in the reforming region 315, and is selectively permeable to hydrogen, elemental and/or molecular, so that hydrogen in the reformed product gas may pass through the membrane wall 323 to the hydrogen conduit 325 while other gases in the reforming region are prevented by the membrane wall 323 from passing to the hydrogen conduit 325.

The high temperature tubular hydrogen-separation membrane(s) 303 in the reforming region may comprise a support coated with a thin layer of a metal or alloy that is selectively permeable to hydrogen. The support may be formed of a ceramic or metallic material that is porous to hydrogen. Porous stainless steel or porous alumina are preferred materials for the support of the membrane 303. The hydrogen selective metal or alloy coated on the support may be selected from metals of Group VIII, including, but not limited to Pd, Pt, Ni, Ag, Ta, V, Y, Nb, Ce, In, Ho, La, Au, and Ru, particularly in the form of alloys. Palladium and platinum alloys are preferred. A particularly preferred membrane 303 used in the present process has a very thin film of a palladium alloy having a high surface area coating a porous stainless steel support. Membranes of this type can be prepared using the methods disclosed in U.S. Pat. No. 6,152,987. Thin films of platinum or platinum alloys having a high surface area would also be suitable as the hydrogen selective material.

The pressure within the reforming region 315 of the reforming reactor 301 is maintained at a level significantly above the pressure within the hydrogen conduit 325 of the tubular membrane 303 so that hydrogen is forced through the membrane wall 323 from the reforming region 315 of the reforming reactor 301 into the hydrogen conduit 325. In an embodiment, the hydrogen conduit 325 is maintained at or near atmospheric pressure, and the reforming region is maintained at a pressure of at least 0.5 MPa, or at least 1.0 MPa, or at least 2 MPa, or at least 3 MPa. As noted above, the reforming region 315 may be maintained at such elevated pressures by compressing the mixture of steam and feed from the pre-reforming reactor with compressor 324 and injecting the mixture of feed and steam at high pressures into the reforming region 315. Alternatively, the reforming region 315 may be maintained at such high pressures by compressing additional steam from heat exchanger 313 with compressor 330 and injecting the high pressure steam into the reforming region 315 of the reforming reactor 301. The reforming region 315 of the reforming reactor 301 may be maintained at a pressure of at least 0.5 MPa, or at least 1.0 MPa, or at least 2.0 MPa, or at least 3.0 MPa.

The temperature at which the feed and steam are mixed and contacted with the reforming catalyst in the reforming region 315 of the reforming reactor 301 is at least 400° C., and preferably may range from 400° C. to 650° C., most preferably in a range of from 450° C. to 550° C. As noted above, unlike typical steam reforming reactions, which produce hydrogen at temperatures in excess of 750° C., the equilibrium of the reforming reaction of the present process is driven towards the production of hydrogen in the reforming reactor 301 operating temperature range of 400° C. to 650° C. since hydrogen is removed from the reforming region 315 into the hydrogen conduit 325 of the hydrogen separation membrane(s) 303. An operating temperature of 400° C. to 650° C. favors the shift reaction as well, converting carbon monoxide and steam to more hydrogen, which is then removed from the reforming region 315 into the hydrogen conduit 325 of the hydrogen separation membrane(s) 303 through the membrane wall 323 of the membrane(s) 303. The fuel cell 305 exhausts may be used to provide the required heat to induce the reforming and shift reactions in the reforming region 315 of the reforming reactor 301 through the exhaust conduits 317 and 319, as described in further detail below.

A non-hydrogen gaseous stream may be removed from the reforming region 315 via line 327, where the non-hydrogen gaseous stream may include unreacted feed, small amounts of hydrogen not separated into the hydrogen conduit 325, and gaseous non-hydrogen reformed products in the reformed product gas. The non-hydrogen reformed products and unreacted feed may include carbon dioxide, water (as steam), and small amounts of carbon monoxide and unreacted hydrocarbons.

In an embodiment, the non-hydrogen gaseous stream separated from the reforming region 315 may be a carbon dioxide gas stream containing at least 0.9, or at least 0.95, or at least 0.98 mole fraction carbon dioxide on a dry basis. The carbon dioxide gas stream may be a high pressure gas stream, having a pressure of at least 1 MPa, or at least 2 MPa, or at least 2.5 MPa. The high pressure carbon dioxide gas stream may contain significant amounts of water as steam as it exits the reforming reactor 301. The water may be removed from the high pressure carbon dioxide gas stream by first passing the stream through heat exchanger 313 via line 327 to exchange heat with the steam and feed precursor being fed to the pre-reforming reactor 314, cooling the high pressure carbon dioxide gas stream. Then, the cooled high pressure carbon dioxide gas stream may be cooled further to condense the water from the stream in one or more heat exchangers 329 (one shown), where the cooled high pressure carbon dioxide stream may be passed to the heat exchanger(s) 329 from heat exchanger 313 via line 331. The dry high pressure carbon dioxide stream may be removed from heat exchanger 329, or final heat exchanger 329 in a series of heat exchangers 329, via line 333. Water condensed from the high pressure carbon dioxide stream in the heat exchanger(s) 329 may be fed to condenser 351 through line 355.

The dry high pressure carbon dioxide stream may be expanded through a turbine 335 to drive the turbine 335 and produce a low pressure carbon dioxide stream. The turbine 335 may be used to generate electricity in addition to electricity generated by the fuel cell 305. Alternatively, the turbine 335 may be used to drive one or more compressors, such as compressors 324, 330, and 361. The low pressure carbon dioxide stream may be sequestered or used for carbonation of beverages.

Alternatively, the high pressure carbon dioxide stream may not be converted to a low pressure carbon dioxide stream, and may be used for enhancing oil recovery from an oil formation by injecting the high pressure carbon dioxide stream into the oil formation.

A first gas stream containing hydrogen may be separated from the reformed product gas in the reforming reactor 301 by selectively passing hydrogen through the membrane wall 323 of the hydrogen separation membrane(s) 303 into the hydrogen conduit 325 of the hydrogen separation membrane(s) 303. The first gas stream may contain a very high concentration of hydrogen, and may contain at least 0.6, or at least 0.7, or at least 0.8, or at least 0.9, or at least 0.95, or at least 0.98 mole fraction hydrogen.

A sweep gas comprising steam may be injected into the hydrogen conduit 325 via line 337 to sweep hydrogen from the inner portion of the membrane wall 323, thereby increasing the rate hydrogen may be separated from the reforming region 315 by the hydrogen separation membrane 303. The first gas stream and steam sweep gas may be removed from the hydrogen separation membrane 303 and the reforming reactor 301 through hydrogen outlet line 339.

The first gas stream and the steam sweep gas may be fed to a heat exchanger 341 via hydrogen outlet line 339 to cool the first gas stream and steam sweep gas. The combined first gas stream and steam sweep gas may have a temperature of from 400° C. to 650° C., typically a temperature of from 450° C. to 550° C., upon exiting the reforming reactor 301. The combined first gas stream and steam sweep gas may exchange heat with the initial feed precursor and water/steam in the heat exchanger 341. The initial feed precursor may be provided to the heat exchanger 341 via line 343, and water/steam may be provided to the heat exchanger 341 via line 345, where the flow rate of the feed precursor and the water may be regulated by valves 342 and 344, respectively. The heated feed precursor and steam may fed to heat exchanger 313 via lines 347 and 349, respectively, for further heating prior to being fed to the pre-reforming reactor 314 as described above. The cooled combined first gas stream and steam sweep gas may be fed to condenser 351 through line 352 to condense water from the combined streams by exchanging heat with water fed into the condenser 351 via line 353 and condensed water separated from the high pressure carbon dioxide gas stream and fed into condenser 351 via line 355.

The water condensed in condenser 351 and water fed to the condenser 351 through lines 353 and 355 may be passed through water trap line 357 to a pump 359 which pumps the water to heat exchanger(s) 329 for heat exchange with the cooled high pressure carbon dioxide gas stream to heat the water while further cooling the cooled high pressure carbon dioxide gas stream. The heated water/steam may be passed to the heat exchanger 341 via line 345, as described above, for further heating to produce steam to be fed to the pre-reforming reactor 314 after further heating in heat exchanger 313.

The cooled first gas stream containing hydrogen and little or no water may be fed from the condenser 351 to a compressor 361 through line 363. The first gas stream may have a pressure at or near atmospheric pressure upon exiting the reforming reactor and being fed through heat exchanger 341 and condenser 351 to the compressor 361. The first gas stream may be compressed in the compressor 361 to increase the pressure of the first gas stream prior to being fed to the fuel cell 305. In an embodiment, the first gas stream may be compressed to a pressure of from 0.15 MPa to 0.5 MPa, and preferably from 0.2 MPa to 0.3 MPa. Energy to drive the compressor 361 may be provided by expansion of the high pressure carbon dioxide stream through turbine 335 coupled to drive the compressor 361.

The first gas stream may then be fed to the anode 307 of the solid oxide fuel cell 305 through line 367 into the anode inlet 365. The first gas stream provides hydrogen to the anode 307 for electrochemical reaction with an oxidant at one or more anode electrodes along the anode path length in the fuel cell 305. The rate the first gas stream is fed to the anode 307 of the fuel cell 305 may be selected by selecting the rate that the feed and steam are fed to the reforming reactor 301, which in turn may be selected by the rate that the feed precursor and water are fed to the pre-reforming reactor 314, which may be controlled by adjusting metering valves 342 and 344 respectively.

A second gas stream containing hydrogen is also fed to the anode 307 of the fuel cell 305. The second gas stream may be separated from the anode exhaust stream, which contains hydrogen and water. The second gas stream may be separated from the anode exhaust stream by cooling the anode exhaust stream sufficiently to condense water from the anode gas exhaust stream to produce the second gas stream containing hydrogen.

The anode exhaust stream exits the anode 307 through the anode exhaust outlet 369. The anode exhaust stream may be initially cooled by exchanging heat with steam and the feed precursor in the pre-reforming reactor 314, and/or by exchanging heat with steam and the feed in the reforming reactor 301.

In an embodiment, the anode exhaust stream may be fed through line 373 to one or more reformer anode exhaust conduits 319 extending into and located within the reforming region 315 of the reforming reactor 301. Heat may be exchanged between the anode exhaust stream and the feed and steam in the reforming region 315 of the reforming reactor 301 as the anode exhaust stream passes through the reforming region 315 in the reformer anode exhaust conduit 319, as described in further detail below, cooling the anode exhaust stream and heating the steam and feed in the reactor 301.

In an embodiment, the anode exhaust stream may be initially cooled by being fed through line 372 to one or more pre-reformer anode exhaust conduits 320 extending into and located within the pre-reforming region 316 of the pre-reforming reactor 314. Heat may be exchanged between the anode exhaust stream and the feed precursor and steam in the pre-reforming region 316 of the pre-reforming reactor 314 as the anode exhaust stream passes through the pre-reforming region 316 in the pre-reformer anode exhaust conduit 320, as described in further detail below, cooling the anode exhaust stream and heating steam and the feed precursor in the pre-reforming reactor 314.

In an embodiment, the anode exhaust stream may be initially cooled by being fed to both the reforming reactor 301 and a pre-reforming reactor 314 through the reformer anode exhaust conduit 319 and through the pre-reformer anode exhaust conduit 320, respectively, as described above. A portion of the anode exhaust stream may be cooled in the reforming reactor 301 by exchanging heat with the feed and steam in the reforming region 315 of the reforming reactor 301 as the anode exhaust passes through the reforming region 315 in the reformer anode exhaust conduit 319. The rest of the anode exhaust may be cooled in the pre-reforming reactor 314 by exchanging heat with the feed precursor and steam in the pre-reforming region 316 of the pre-reforming reactor 314 as the anode exhaust passes through the pre-reforming region 316 in the pre-reformer anode exhaust conduit 320.

In another embodiment, the anode exhaust stream may be initially cooled by being fed first to the pre-reforming reactor 314, then being fed from the pre-reforming reactor 314 to the reforming reactor 301. The anode exhaust stream may be fed from the anode exhaust outlet 369 to the pre-reformer anode exhaust conduit 320 via line 372 to be cooled by exchanging heat with the feed precursor and steam in the pre-reforming region 316 of the pre-reforming reactor 314. The anode exhaust stream may then be fed from the pre-reformer anode exhaust conduit 320 to the reforming reactor 301 via line 374, where the anode exhaust stream may be fed to the reformer anode exhaust conduit 319 for further cooling by exchanging heat with the feed and steam in the reforming region 315 of the reforming reactor 301 as the anode exhaust stream passes through the reformer anode exhaust conduit 319. Cooling the anode exhaust stream first by exchanging heat in the pre-reforming reactor 314 with the feed precursor and steam and subsequently by exchanging heat in the reforming reactor 301 with the feed and steam may be particularly effective for driving the respective pre-reforming and reforming reactions since the pre-reforming reaction requires more heat than the reforming reaction, and the reforming reaction may be run at a cooler temperature than the pre-reforming reaction to avoid heat damage to the high temperature hydrogen separation membrane 303 located in the reforming region 315 of the reforming reactor 301.

Metering valves 370 and 371 may be used to control the amount of the anode exhaust stream directed to the reforming reactor 301 and/or the pre-reforming reactor 314. The metering valves 370 and 371 may be adjusted to select the flow of the anode exhaust stream either to the reforming reactor 301 or to the pre-reforming reactor 314. Valve 368 may be used to control the flow of the anode exhaust stream from the pre-reformer anode exhaust conduit 320 to the reformer anode exhaust conduit 319 or from the pre-reformer anode exhaust conduit 320 to be combined with the cooled anode exhaust stream exiting the reformer anode exhaust conduit 319 as described below.

The cooled anode exhaust stream exits the reformer anode exhaust conduit 319 and/or the pre-reformer anode exhaust conduit 320 and may be cooled further to separate the second gas stream containing hydrogen from water in the anode exhaust stream. If any cooled anode exhaust stream exiting the pre-reforming reactor 314 is not passed to the reformer anode exhaust conduit 319 for further heat exchange in the reforming reactor 301, the cooled anode exhaust stream from the pre-reforming reactor 314 may be passed to heat exchanger 341 for further cooling through lines 378 and 382. If any cooled anode exhaust stream exits the reforming reactor 301, the cooled anode exhaust stream may be passed to heat exchanger 341 through line 382 for further cooling. Cooled anode exhaust streams exiting both the reforming reactor 301 and the pre-reforming reactor 314 may be combined in line 382 and passed to heat exchanger 341 for further cooling. The cooled anode exhaust stream exiting either the reformer anode exhaust conduit 319, the pre-reformer anode exhaust conduit 320, or both is further cooled in heat exchanger 341 by exchanging heat with the feed precursor from line 343 and steam from line 345.

In one embodiment, to control the flow rate of the second gas stream to the fuel cell 305, at least a portion of the anode exhaust stream may be passed from heat exchanger 341 to a condenser 375 via line 376 to separate hydrogen from water in the selected portion of the anode exhaust stream. Hydrogen may be separated from the selected portion of the anode exhaust stream by condensing water from the anode exhaust stream in the condenser 375. The separated hydrogen may be fed to a hydrogen storage tank 377 through line 379. Water condensed from condenser 375 may be fed to pump 359 through line 380.

Cooled anode exhaust stream not fed to condenser 375 for separation into the hydrogen tank 377 is used to provide the second gas stream to the fuel cell 305. The anode exhaust stream exiting the heat exchanger 341 may be mixed with the first gas stream and steam sweep gas by feeding the anode exhaust stream through line 381 to line 352. The mixture of anode exhaust stream, first gas stream, and steam sweep gas may be then fed to condenser 351 to further cool the anode exhaust stream. The second gas stream, derived from condensing water from the anode exhaust stream, may be separated from the condenser 351 via line 363 mixed together with the first gas stream. The second gas stream may contain at least 0.6, or at least 0.7, or at least 0.8, or at least 0.9, or at least 0.95, or at least 0.98 mole fraction hydrogen, where the hydrogen content of the second gas stream may be determined by determining the hydrogen content of the cooled anode exhaust stream on a dry basis. Water from the anode exhaust stream may be condensed in condenser 351 together with water from the first gas stream and the steam sweep gas, and removed from the condenser 351 through line 357 to be fed to pump 359.

Metering valves 383 and 385 may be used to select the rate of flow of the second gas stream to the solid oxide fuel cell 305. The flow rate of the second gas stream to the solid oxide fuel cell 305 may be selected by adjusting valves 383 and 385 in coordination to meter the flow rate of the anode exhaust stream to condenser 351 which regulates the rate of the second gas stream to the solid oxide fuel cell 305. Valve 383 may be completely closed, blocking flow of the anode exhaust stream to condenser 375 and hydrogen to the hydrogen tank 377, and valve 385 may be completely opened to allow the entire anode exhaust stream to flow to the condenser 351 and the second gas stream to flow to the solid oxide fuel cell 305 at a maximum flow rate. In a preferred embodiment, the flow rate of the second gas stream to the fuel cell 305 may be automatically controlled to a selected rate by automatically adjusting the metering valves 383 and 385 in response to the water and/or hydrogen content of the anode exhaust stream.

In an embodiment, a small portion of the combined first and second gas streams may be passed through a hydrogen separation device 387 as a bleed stream to remove any small amounts of carbon oxides that may be present in the first and second gas streams as a result of imperfect separation of hydrogen from carbon oxides by the hydrogen separation membrane 303 in the reforming reactor 301 when producing the first gas stream and its subsequent recycle in the second gas stream. Valves 389 and 391 may be utilized to control the flow of the bleed stream to the hydrogen separation device 387, where preferably valves 389 and 391 may permit a metered flow of the first and second gas streams simultaneously through lines 393 and 395, or, alternatively, separately through either line 393 or line 395. The hydrogen separation device 387 is preferably a pressure swing adsorption apparatus effective for separating hydrogen from carbon oxides, or may be a membrane selectively permeable to hydrogen such as those described above. The first and second gas streams in lines 395 and 397 may be combined to be fed to the solid oxide fuel cell 305 through line 367.

In an embodiment of the process, the temperature and pressure of the first and second gas streams may be selected for effective operation of the solid oxide fuel cell 305. In particular, the temperature should not be so low as to inhibit the electrochemical reactivity of the fuel cell and should not be so high as to induce an uncontrolled exothermic reaction in the fuel cell 305. In an embodiment, the temperature of the combined first and second gas streams fed to the fuel cell 305 may range from 25° C. to 300° C., or from 50° C. to 200° C., or from 75° C. to 150° C. The pressure of the combined first and second streams may be controlled by compressor 361, and may be from 0.15 MPa to 0.5 MPa, or from 0.2 MPa to 0.3 MPa.

An oxygen containing gas stream may be fed to the cathode 399 of the fuel cell through cathode inlet 401 via line 403. The oxygen containing gas stream may be provided by an air compressor or an oxygen tank (not shown). In an embodiment, the oxygen containing gas stream may be air or pure oxygen. In another embodiment, the oxygen containing gas stream may be an oxygen enriched air stream containing at least 21% oxygen, where the oxygen enriched air stream provides higher electrical efficiency in the solid oxide fuel cell than air since the oxygen enriched air stream contains more oxygen for conversion into ionic oxygen in the fuel cell.

The oxygen containing gas stream may be heated prior to being fed to the cathode 399 of the fuel cell 305. In one embodiment, the oxygen containing gas stream may be heated to a temperature of from 150° C. to 350° C. prior to being fed to the cathode 399 of the fuel cell 305 in heat exchanger 405 by exchanging heat with a portion of the cathode exhaust provided to the heat exchanger 405 from the cathode exhaust outlet 407 via line 409. The flow rate of the cathode exhaust stream to the heat exchanger 405 may be controlled with metering valve 411. Alternatively, the oxygen containing gas stream may be heated by an electrical heater (not shown), or the oxygen containing gas stream may be provided to the cathode 399 of the fuel cell 305 without heating.

The solid oxide fuel cell 305 used in this embodiment of the process of the invention may be a conventional solid oxide fuel cell, preferably having a planar or tubular configuration, and is comprised of an anode 307, a cathode 399, and an electrolyte 413 where the electrolyte 413 is interposed between the anode 307 and the cathode 399. The solid oxide fuel cell may be comprised of a plurality of individual fuel cells stacked together-joined electrically by interconnects and operatively connected so that a fuel may flow through the anodes of the stacked fuel cells and an oxygen containing gas may flow through the cathodes of the stacked fuel cells. The solid oxide fuel cell may be either a single solid oxide fuel cell or a plurality of operatively connected or stacked solid oxide fuel cells. In an embodiment, the anode 307 is formed of a Ni/ZrO₂ cermet, the cathode 399 is formed of a doped lanthanum manganite or stabilized ZrO₂ impregnated with praseodymium oxide and covered with SnO doped In₂O₃, and the electrolyte 413 is formed of yttria stabilized ZrO₂ (approximately 8 mol % Y₂O₃). The interconnect between stacked individual fuel cells or tubular fuel cells may be a doped lanthanum chromite.

The solid oxide fuel cell 305 is configured so that the first and second gas streams may flow through the anode 307 of the fuel cell 305 from the anode inlet 365 to the anode exhaust outlet 369, contacting one or more anode electrodes over the anode path length from the anode inlet 365 to the anode exhaust outlet 369. The fuel cell 305 is also configured so that the oxygen containing gas may flow through the cathode 399 from the cathode inlet 401 to the cathode exhaust outlet 407, contacting one or more cathode electrodes over the cathode path length from the cathode inlet 401 to the cathode exhaust outlet 407. The electrolyte 413 is positioned in the fuel cell 305 to prevent the first and second gas streams from entering the cathode and to prevent the oxygen containing gas from entering the anode, and to conduct ionic oxygen from the cathode to the anode for electrochemical reaction with hydrogen in the first and second gas streams at the one or more anode electrodes.

The solid oxide fuel cell 305 is operated at a temperature effective to enable ionic oxygen to traverse the electrolyte 413 from the cathode 399 to the anode 307 of the fuel cell 305. The solid oxide fuel cell 305 may be operated at a temperature of from 700° C. to 1100° C., or from 800° C. to 1000° C. The oxidation of hydrogen with ionic oxygen at the one or more anode electrodes is a very exothermic reaction, and the heat of reaction generates the heat required to operate the solid oxide fuel cell 305. The temperature at which the solid oxide fuel cell 305 is operated may be controlled by independently controlling the temperature of the first gas stream, the temperature of the second gas stream, and the temperature of the oxygen containing gas stream, and the flow rates of these streams to the fuel cell 305. In an embodiment, the temperature of the second gas stream is controlled to a temperature of at most 150° C., the temperature of the oxygen containing gas stream is controlled to a temperature of at most 300° C., and the temperature of the first gas stream is controlled to a temperature of at most 150° C. to maintain the operating temperature of the solid oxide fuel cell in a range from 700° C. to 1000° C., and preferably in a range of from 800° C. to 900° C.

To initiate operation of the fuel cell 305, the fuel cell 305 is heated to its operating temperature. In a preferred embodiment, operation of the solid oxide fuel cell 305 may be initiated by generating a hydrogen containing gas stream in a catalytic partial oxidation reforming reactor 433 and feeding the hydrogen containing gas stream through line 435 to the anode 307 of the solid oxide fuel cell. A hydrogen containing gas stream may be generated in the catalytic partial oxidation reforming reactor 433 by combusting a hydrocarbon feed and an oxygen source in the catalytic partial oxidation reforming reactor 433 in the presence of a conventional partial oxidation reforming catalyst, where the oxygen source is fed to the catalytic partial oxidation reforming reactor 433 in a substoichiometric amount relative to the hydrocarbon feed.

The hydrocarbon feed fed to the catalytic partial oxidation reforming reactor 433 may be a liquid or gaseous hydrocarbon or mixtures of hydrocarbons, and preferably is methane, natural gas, or other low molecular weight hydrocarbon or mixture of low molecular weight hydrocarbons. In a particularly preferred embodiment of the process of the invention, the hydrocarbon feed fed to the catalytic partial oxidation reforming reactor 433 may be a feed of the same type as the feed precursor used in the pre-reforming reactor 314 to reduce the number of hydrocarbon feeds required run the process.

The oxygen containing feed fed to the catalytic partial oxidation reforming reactor 433 may be pure oxygen, air, or oxygen enriched air. The oxygen containing feed should be fed to the catalytic partial oxidation reforming reactor 433 in substoichiometric amounts relative to the hydrocarbon feed to combust with the hydrocarbon feed in the catalytic partial oxidation reforming reactor 433.

The hydrogen containing gas stream formed by combustion of the hydrocarbon feed and the oxygen containing gas in the catalytic partial oxidation reforming reactor 433 contains compounds that may be oxidized in the anode 307 of the fuel cell 305 by contact with an oxidant at one or more of the anode electrodes, including hydrogen and carbon monoxide, as well as other compounds such as carbon dioxide. The hydrogen containing gas steam from the catalytic partial oxidation reforming reactor 433 preferably does not contain compounds that may oxidize the one or more anode electrodes in the anode 307 of the fuel cell 305.

The hydrogen containing gas stream formed in the catalytic partial oxidation reforming reactor 433 is hot, and may have a temperature of at least 700° C., or from 700° C. to 1100° C., or from 800° C. to 1000° C. Use of the hot hydrogen gas stream from a catalytic partial oxidation reforming reactor 433 to initiate start up of the solid oxide fuel cell 305 is preferred in the process of the invention since it enables the temperature of the fuel cell 305 to be raised to the operating temperature of the fuel cell 305 almost instantaneously. In an embodiment, heat may be exchanged in heat exchanger 405 between the hot hydrogen containing gas from the catalytic partial oxidation reforming reactor 433 and an oxygen containing gas fed to the cathode 399 of the fuel cell 305 when initiating operation of the fuel cell 305.

Upon reaching the operating temperature of the fuel cell 305, the flow of the hot hydrogen containing gas stream from the catalytic partial oxidation reforming reactor 433 into the fuel cell 305 may be shut off by valve 439, while feeding the first gas stream from the reforming reactor 301 into the anode 307 by opening valve 441 and feeding an oxygen containing gas stream into the cathode 399 of the fuel cell 305. Continuous operation of the fuel cell may then conducted according to the process of the invention.

In another embodiment (not shown in FIG. 3), operation of the fuel cell 305 may be initiated with a hydrogen start-up gas stream from the hydrogen storage tank 377 that may be passed through a start-up heater to bring the fuel cell up to its operating temperature prior to introducing the first gas stream into the fuel cell. The hydrogen storage tank may be operatively connected to the fuel cell to permit introduction of the hydrogen start-up gas stream into the anode of the solid oxide fuel cell. The start-up heater may indirectly heat the hydrogen start-up gas stream to a temperature of from 750° C. to 1000° C. The start-up heater may be an electrical heater or may be a combustion heater. Upon reaching the operating temperature of the fuel cell, the flow of the hydrogen start-up gas stream into the fuel cell may be shut off by a valve, and the first gas stream may be introduced into the fuel cell to start continuous operation of the fuel cell.

During initiation of operation of the fuel cell 305, an oxygen containing gas stream may be introduced into the cathode 399 of the fuel cell 305. The oxygen containing gas stream may be air, oxygen enriched air containing at least 21% oxygen, or pure oxygen. Preferably, the oxygen containing gas stream is the oxygen containing gas stream that will be fed to the cathode 399 during operation of the fuel cell 305 after initiating operation of the fuel cell.

In a preferred embodiment, the oxygen containing gas stream fed to the cathode 399 of the fuel cell during start-up of the fuel cell has a temperature of at least 500° C., more preferably at least 650° C., and more preferably at least 750° C. The oxygen containing gas stream may be heated by an electric heater before being fed to the cathode 399 of the solid oxide fuel cell 305. In a preferred embodiment, the oxygen containing gas stream used in initiating operation of the fuel cell 305 may be heated by heat exchange with a hot hydrogen containing gas stream from a catalytic partial oxidation reforming reaction in heat exchanger 405 prior to being fed to the cathode 399 of the fuel cell 305.

Once operation of the fuel cell has commenced, the first and second gas streams may be mixed with an ionic oxygen oxidant at one or more anode electrodes in the fuel cell 305 to generate electricity. The ionic oxygen oxidant is derived from oxygen in the oxygen-containing gas stream flowing through the cathode 399 of the fuel cell 305 and conducted across the electrolyte 413 of the fuel cell. The first and second gas streams fed to the anode 307 of the fuel cell 305 and the oxidant are mixed in the anode 307 at the one or more anode electrodes of the fuel cell 305 by feeding the first gas stream, the second gas stream, and the oxygen containing gas stream to the fuel cell 305 at selected independent rates while operating the fuel cell at a temperature of from 750° C. to 1100° C.

The first and second gas streams and the oxidant are preferably mixed at the one or more anode electrodes of the fuel cell 305 to generate electricity at an electrical power density of at least 0.4 W/cm², more preferably at least 0.5 W/cm², or at least 0.75 W/cm², or at least 1 W/cm², or at least 1.25 W/cm², or at least 1.5 W/cm². Electricity may be generated at such electrical power densities by selecting and controlling the rates that the first and second gas streams are fed to the anode 307 of the fuel cell 305. The flow rate of the first gas stream to the anode 307 of the fuel cell 305 may be selected and controlled by selecting and controlling the rate that the feed and steam are fed to the reforming reactor 301, which in turn is controlled by the rate that the feed precursor and steam are fed to the pre-reforming reactor 314 which is controlled by adjusting metering valves 342 and 344, respectively. The flow rate of the second gas stream to the anode 307 of the fuel cell 305 may be selected and controlled by selecting and controlling the flow rate of the anode exhaust stream to the condenser 351 by adjusting metering valves 383 and 385 as described above. In an embodiment, metering valves 383 and 385 may be automatically adjusted by a feedback circuit (not shown) that measures water and/or hydrogen content in the anode exhaust stream, and adjusts the metering valves 383 and 385 to maintain a selected water and/or hydrogen content in the anode exhaust stream.

In the process of the invention, mixing the first and second gas streams and the oxidant at the one or more anode electrodes generates water (as steam) by the oxidation of a portion of hydrogen present in the first and second gas streams fed to the fuel cell 305 with the oxidant. Water generated by the oxidation of hydrogen with an oxidant is swept through the anode 307 of the fuel cell 305 by the unreacted portion of the first and second gas streams to exit the anode 307 as part of the anode exhaust stream.

In an embodiment of the process of the invention, the flow rate that the first and second gas streams are fed to the anode 307 may be independently selected so the ratio of amount of water formed in the fuel cell 305 per unit of time to the amount of hydrogen in the anode exhaust per unit of time is at most 1.0, or at most 0.75, or at most 0.67, or at most 0.43, or at most 0.25, or at most 0.11. In an embodiment, the amount of water formed in the fuel cell 305 and the amount of hydrogen in the anode exhaust may be measured in moles so that the ratio of the amount of water formed in the fuel cell per unit of time to the amount of hydrogen in the anode exhaust per unit of time in moles per unit of time is at most 1.0, or at most 0.75, or at most 0.67, or at most 0.43, or at most 0.25, or at most 0.11. In another embodiment of the process of the invention, the flow rate that the first and second gas streams are fed to the anode 307 may be independently selected so the anode exhaust stream contains at least 0.6, or at least 0.7, or at least 0.8, or at least 0.9 mole fraction hydrogen. In an embodiment, the flow rate that the first and second gas streams are fed to the anode 307 may be independently selected so the anode exhaust stream contains at least 50%, or at least 60%, or at least 70%, or at least 80%, or at least 90% of the hydrogen in the combined first and second gas streams fed to the anode 307. In an embodiment, the flow rate that the first and second gas streams are fed to the anode 307 may be independently selected so the per pass hydrogen utilization rate in the fuel cell 305 is at most 50%, or at most 40%, or at most 30%, or at most 20%, or at most 10%.

The flow rate of the oxygen containing gas stream provided to the cathode 399 of the solid oxide fuel cell 305 should be selected to provide sufficient oxidant to the anode to generate electricity at an electrical power density of at least 0.4 W/cm², or at least 0.5 W/cm², or at least 0.75 W/cm², or at least 1 W/cm², or at least 1.25 W/cm², or at least 1.5 W/cm² when combined with the fuel from the first and second gas streams at the one or more anode electrodes. The flow rate of the oxygen containing gas stream to the cathode 399 may be selected and controlled by adjusting metering valve 415.

In one embodiment of the process of the present invention, the reforming reactor 301 and the solid oxide fuel cell 305 may be thermally integrated so the heat from the exothermic electrochemical reaction in the fuel cell 305 is provided to the reforming region 315 of the reforming reactor 301 to drive the endothermic reforming reaction in the reforming reactor 301. As described above, one or more reformer anode exhaust conduits 319 and/or one or more reformer cathode exhaust conduits 317 extend into and are located within the reforming region 315 of the reforming reactor 301. A hot anode exhaust stream may exit the anode 307 of the fuel cell 305 from the anode exhaust outlet 369 and enter the reformer anode exhaust conduit 319 in the reforming region 315 via line 373, and a hot cathode exhaust stream may exit the cathode 399 of the fuel cell 305 from the cathode exhaust outlet 407 and enter the reformer cathode exhaust conduit 317 in the reforming region 315 via line 417. Heat from the hot anode exhaust stream may be exchanged between the anode exhaust stream and the mixture of steam and feed in the reforming region 315 as the anode exhaust stream passes through the reformer anode exhaust conduit 319. Likewise, heat from the hot cathode exhaust stream may be exchanged between the cathode exhaust stream and the mixture of steam and feed in the reforming region 315 of the reforming reactor 301 as the cathode exhaust stream passes through the reformer cathode exhaust conduit 317.

The heat exchange from the exothermic solid oxide fuel cell 305 to the endothermic reforming reactor 301 is highly efficient. Location of the reformer anode exhaust conduit(s) 319 and/or the reformer cathode exhaust conduit(s) 317 within the reforming region 315 of the reforming reactor 301 permits exchange of heat between the hot anode and/or cathode exhaust streams and the mixture of feed and steam within the reactor 301, transferring heat to the feed and steam at the location that the reforming reaction takes place. Further, location of the reformer anode and/or cathode exhaust conduits 319 and 317 within the reforming region 315 permits the hot anode and/or cathode exhaust streams to heat the reforming catalyst in the reforming region 315 as a result of the close proximity of the conduits 317 and 319 to the catalyst bed.

Further, no additional heat other than provided by the anode exhaust stream and/or the cathode exhaust stream needs to be provided to the reforming reactor 301 to drive the reforming and shift reactions in the reactor 301 to produce the reformed product gas and the first gas stream. As noted above, the temperature required to run the reforming and shift reactions within the reforming reactor 301 is from 400° C. to 650° C., which is much lower than conventional reforming reactor temperatures—which are at least 750° C., and typically 800° C.-900° C. The reforming reactor may be run at such low temperatures due to the equilibrium shift in the reforming reaction engendered by separation of hydrogen from the reforming reactor 301 by the high temperature hydrogen separation membrane 303. The anode exhaust stream and the cathode exhaust stream may have a temperature of from 800° C. to 1000° C., which, upon heat exchange between the anode exhaust stream and/or the cathode exhaust stream with the mixture of feed and steam, is sufficient to drive the lower temperature reforming and shift reactions in the reforming reactor 301.

In an embodiment of the process of the invention, the exchange of heat between the anode exhaust stream and the mixture of steam and feed in the reforming region 315 as the anode exhaust stream passes through the reformer anode exhaust conduit 319 may provide a significant amount of the heat provided to the mixture of steam and feed in the reactor 301 to drive the reforming and shift reactions. In an embodiment of the process of the invention, the exchange of heat between the anode exhaust stream and the mixture of steam and feed in the reactor 301 may provide at least 40%, or at least 50%, or at least 70%, or at least 90% of the heat provided to the mixture of steam and feed in the reactor 301. In an embodiment, the heat supplied to the mixture of steam and feed in the reforming reactor 301 consists essentially of the heat exchanged between the anode exhaust stream passing through the reformer anode exhaust conduit 319 and the mixture of steam and feed in the reforming reactor 301. In an embodiment of the process, the exchange of heat between the anode exhaust stream and the mixture of steam and feed in the reactor 301 may be controlled to maintain the temperature of the mixture of steam and feed in a range of from 400° C. to 650° C.

In an embodiment of the process of the invention, the exchange of heat between the cathode exhaust stream and the mixture of steam and feed in the reforming region 315 as the cathode exhaust stream passes through the reformer cathode exhaust conduit 317 may provide a significant amount of the heat provided to the mixture of steam and feed in the reactor 301 to drive the reforming and shift reactions. In an embodiment of the process of the invention, the exchange of heat between the cathode exhaust stream and the mixture of steam and feed in the reactor 301 may provide at least 40%, or at least 50%, or at least 70%, or at least 90% of the heat provided to the mixture of steam and feed in the reactor 301. In an embodiment, the heat supplied to the mixture of steam and feed in the reforming reactor 301 consists essentially of the heat exchanged between the cathode exhaust stream passing through the reformer cathode exhaust conduit 317 and the mixture of steam and feed in the reforming reactor 301. In an embodiment of the process, the exchange of heat between the cathode exhaust stream and the mixture of steam and feed in the reactor 301 may be controlled to maintain the temperature of the mixture of steam and feed in a range of from 400° C. to 650° C.

In an embodiment, the exchange of heat between the anode exhaust stream, the cathode exhaust stream, and the mixture of steam and feed in the reforming region 315 as the anode exhaust stream passes through the reformer anode exhaust conduit 319 and the cathode exhaust stream passes through the reformer cathode exhaust conduit 317 may provide a significant amount of the heat provided to the mixture of steam and feed in the reactor 301 to drive the reforming and shift reactions. In an embodiment of the process of the invention, the exchange of heat between the anode exhaust stream, the cathode exhaust stream, and the mixture of steam and feed in the reactor 301 may provide at least 40%, or at least 50%, or at least 70%, or at least 90%, or at least 95%, or at least 99% of the heat provided to the mixture of steam and feed in the reactor 301. In an embodiment of the process of the invention, the exchange of heat between the cathode exhaust stream and the mixture of steam and feed in the reactor 301 may provide up to 60%, or up to 50%, or up to 40%, or up to 30%, or up to 20% of the heat provided to the mixture of steam and feed in the reactor 301 while the exchange of heat between the anode exhaust stream and the mixture of steam and feed in the reactor 301 may provide at least 40%, or at least 50%, or at least 60%, or at least 70%, or at least 80% of the heat provided to the mixture of steam and feed in the reactor 301. In an embodiment, the heat supplied to the mixture of steam and feed in the reforming reactor 301 may consist essentially of heat exchanged between the anode and cathode exhaust streams and the mixture of steam and feed in the reactor 301. In an embodiment of the process, the exchange of heat between the anode and cathode exhaust streams and the mixture of steam and feed in the reactor 301 may be controlled to maintain the temperature of the mixture of steam and feed in a range of from 400° C. to 650° C.

In a preferred embodiment, the heat provided by the anode exhaust stream or cathode exhaust stream or the anode and cathode exhaust streams to the mixture of steam and feed in the reforming reactor 301 is sufficient to drive the reforming and shift reactions in the reforming reactor 301 such that no other source of heat is required to drive the reactions in the reforming reactor 301. Most preferably, no heat is provided to the mixture of steam and feed in the reforming reactor 301 by electrical heating or combustion.

In an embodiment, the anode exhaust stream provides most, or all, of the heat to the mixture of steam and feed in the reforming reactor 301 to drive the reforming and shift reactions in the reactor. Metering valves 371 and 370 may be adjusted to control the flow of the anode exhaust stream from the fuel cell to the reformer anode exhaust conduit 319, where the flow of the anode exhaust stream through the valve 371 may be increased and its flow through valve 370 may be decreased to increase flow of the anode exhaust stream into the reformer anode exhaust conduit 319 to provide the heat required to drive the reforming and shift reactions in reforming reactor 301.

In this embodiment only some, or none, of the cathode exhaust stream is required to exchange heat with the mixture of steam and feed in the reforming reactor 301 to drive the reforming and shift reactions. The flow of the cathode exhaust stream through the reforming cathode exhaust conduit 317 in the reforming reactor 301 may be controlled to control the amount of heat provided to the mixture of steam and feed in the reforming reactor 301 from the cathode exhaust stream. Metering valves 411, 412, 429, and 431 may be adjusted to control the flow of the cathode exhaust stream to the reformer cathode exhaust conduit 317 such that the cathode exhaust stream provides the desired amount of heat, if any, to the mixture of steam and feed in the reactor 301. To decrease the flow of cathode exhaust to the reforming reactor 301 through the reformer cathode exhaust conduit 317, valves 412 and 431 may be adjusted to decrease flow of the cathode exhaust through valves 412 and 431 and valves 411 and 429 may be adjusted to increase flow of the cathode exhaust through valves 411 and 429.

In an embodiment, the cathode exhaust stream provides most, or all, of the heat to the mixture of steam and feed in the reforming reactor 301 to drive the reforming and shift reactions in the reactor. Metering valves 411, 412, 429, and 431 may be adjusted to control the flow of the cathode exhaust stream to the reformer cathode exhaust conduit 317 such that the cathode exhaust stream provides the desired amount of heat to the mixture of steam and feed in the reactor 301. To increase the flow of cathode exhaust to the reforming reactor 301 through the reformer cathode exhaust conduit 317, valves 412 and 431 may be adjusted to increase flow of the cathode exhaust through valves 412 and 431 and valves 411 and 429 may be adjusted to decrease flow of the cathode exhaust through valves 411 and 429.

In this embodiment only some, or none, of the anode exhaust stream is required to exchange heat with the mixture of steam and feed in the reforming reactor 301 to drive the reforming and shift reactions. The flow of the anode exhaust stream through the reforming anode exhaust conduit 319 in the reforming reactor 301 may be controlled to control the amount of heat provided to the mixture of steam and feed in the reforming reactor 301 from the anode exhaust stream. Metering valves 371 and 370 may be adjusted to control the flow of the anode exhaust stream from the fuel cell 305 to the reformer anode exhaust conduit 319, where anode exhaust stream flow through the valve 371 may be decreased and its flow through the valve 370 may be increased to decrease flow of the anode exhaust stream into the reformer anode exhaust conduit 319.

The cooled cathode exhaust stream that has passed through the reformer cathode exhaust conduit 317 may still have a significant amount of heat therein, and may have a temperature of up to 650° C. The cooled cathode exhaust stream may be passed out of the cathode exhaust conduit through outlet 418 to be fed to the oxygen containing gas heat exchanger 405 through line 419 along with any cathode exhaust stream metered to the heat exchanger 405 through valve 411. The cooled anode exhaust stream that has passed through the reformer anode exhaust conduit 319 is treated as described above to provide the second gas stream to the fuel cell 305.

In one embodiment of the process of the present invention, the pre-reforming reactor 314 and the solid oxide fuel cell 305 may be thermally integrated so the heat from the exothermic electrochemical reaction in the fuel cell 305 is provided to the pre-reforming region 316 of the pre-reforming reactor 314 to drive the endothermic vaporization and cracking/reforming reactions in the pre-reforming reactor 314. As described above, one or more pre-reformer anode exhaust conduits 320 and/or one or more pre-reformer cathode exhaust conduits 322 extend into and are located within the pre-reforming region 316 of the pre-reforming reactor 314. A hot anode exhaust stream may exit the anode 307 of the fuel cell 305 from the anode exhaust outlet 369 and enter the pre-reformer anode exhaust conduit 320 in the pre-reforming region 316 via line 372, and a hot cathode exhaust stream may exit the cathode 399 of the fuel cell 305 from the cathode exhaust outlet 407 and enter the pre-reformer cathode exhaust conduit 322 in the pre-reforming region 316 via line 421. Heat from the hot anode exhaust stream may be exchanged between the anode exhaust stream and the mixture of steam and feed precursor in the pre-reforming region 316 as the anode exhaust stream passes through the pre-reformer anode exhaust conduit 320. Likewise, heat from the hot cathode exhaust stream may be exchanged between the cathode exhaust stream and the mixture of steam and feed precursor in the pre-reforming region 316 of the pre-reforming reactor 314 as the cathode exhaust stream passes through the pre-reformer cathode exhaust conduit 322.

The heat exchange from the exothermic solid oxide fuel cell 305 to the endothermic pre-reforming reactor 314 is highly efficient. Location of the pre-reformer anode exhaust conduit(s) 320 and/or the pre-reformer cathode exhaust conduit(s) 322 within the pre-reforming region 316 of the pre-reforming reactor 314 permits exchange of heat between the hot anode and/or cathode exhaust streams and the mixture of feed precursor and steam within the reactor 314, transferring heat to the feed precursor and steam at the location that the vaporization/cracking/reforming reactions take place. Further, location of the pre-reformer anode and/or cathode exhaust conduits 320 and 322 within the pre-reforming region 316 permits the hot anode and/or cathode exhaust streams to heat the pre-reforming catalyst in the pre-reforming region 316 as a result of the close proximity of the conduits 320 and 322 to the catalyst bed.

Further, no additional heat other than provided by the anode exhaust stream and/or the cathode exhaust stream, needs to be provided to the pre-reforming reactor 314 to drive the vaporization/cracking/reforming reactions in the pre-reforming reactor 314 to produce the feed for the reforming reactor 301. The temperature required to crack or reform the feed precursor hydrocarbons to hydrocarbons useful as feed for the reforming reactor may be from 400° C. to 850° C., or from 500° C. to 800° C., and may be higher than required to reform the feed in the reforming reactor 301. The anode exhaust stream and the cathode exhaust stream may have a temperature of from 800° C. to 1000° C., which, upon heat exchange between the anode exhaust stream and/or the cathode exhaust stream and the mixture of feed precursor and steam, is sufficient to drive the conversion of feed precursors to feed in the pre-reforming reactor 314.

In an embodiment of the process of the invention, the exchange of heat between the anode exhaust stream and the mixture of steam and feed precursor in the pre-reforming region 316 as the anode exhaust stream passes through the pre-reformer anode exhaust conduit 320 may provide a significant amount of the heat provided to the mixture of steam and feed precursor in the pre-reforming reactor 314 to drive the vaporization/cracking/reforming reactions. In an embodiment of the process of the invention, the exchange of heat between the anode exhaust stream and the mixture of steam and feed precursor in the pre-reforming reactor 314 may provide at least 40%, or at least 50%, or at least 70%, or at least 90% of the heat provided to the mixture of steam and feed precursor in the pre-reforming reactor 314. In an embodiment, the heat supplied to the mixture of steam and feed precursor in the pre-reforming reactor 314 consists essentially of the heat exchanged between the anode exhaust stream passing through the pre-reformer anode exhaust conduit 320 and the mixture of steam and feed precursor in the pre-reforming reactor 314. In an embodiment of the process, the exchange of heat between the anode exhaust stream and the mixture of steam and feed in the pre-reforming reactor 314 may be controlled to maintain the temperature of the mixture of steam and feed precursor in a range of from 500° C. to 800° C.

In an embodiment of the process of the invention, the exchange of heat between the cathode exhaust stream and the mixture of steam and feed precursor in the pre-reforming region 316 as the cathode exhaust stream passes through the pre-reformer cathode exhaust conduit 322 may provide a significant amount of the heat provided to the mixture of steam and feed precursor in the pre-reforming reactor 314 to drive the vaporization/cracking/reforming reactions. In an embodiment of the process of the invention, the exchange of heat between the cathode exhaust stream and the mixture of steam and feed precursor in the pre-reforming reactor 314 may provide at least 40%, or at least 50%, or at least 70%, or at least 90% of the heat provided to the mixture of steam and feed precursor in the pre-reforming reactor 314. In an embodiment, the heat supplied to the mixture of steam and feed precursor in the pre-reforming reactor 314 consists essentially of the heat exchanged between the cathode exhaust stream passing through the pre-reformer cathode exhaust conduit 322 and the mixture of steam and feed precursor in the pre-reforming reactor 314. In an embodiment of the process, the exchange of heat between the cathode exhaust stream and the mixture of steam and feed precursor in the pre-reforming reactor 314 may be controlled to maintain the temperature of the mixture of steam and feed precursor in a range of from 500° C. to 800° C.

In an embodiment, the exchange of heat between the anode exhaust stream, the cathode exhaust stream, and the mixture of steam and feed precursor in the pre-reforming region 316 as the anode exhaust stream passes through the pre-reformer anode exhaust conduit 320 and the cathode exhaust stream passes through the pre-reformer cathode exhaust conduit 322 may provide a significant amount of the heat provided to the mixture of steam and feed precursor in the pre-reforming reactor 314 to drive the vaporization/cracking/reforming reactions. In an embodiment of the process of the invention, the exchange of heat between the anode exhaust stream, the cathode exhaust stream, and the mixture of steam and feed precursor in the pre-reforming reactor 314 may provide at least 40%, or at least 50%, or at least 70%, or at least 80%, or at least 90%, or at least 95%, or at least 99% of the heat provided to the mixture of steam and feed precursor in the reactor 314. In an embodiment of the process of the invention, the exchange of heat between the cathode exhaust stream and the mixture of steam and feed precursor in the reactor 314 may provide up to 60%, or up to 50%, or up to 40%, or up to 30%, or up to 20% of the heat provided to the mixture of steam and feed precursor in the reactor 314, while the exchange of heat between the anode exhaust stream and the mixture of steam and feed precursor may provide at least 40%, or at least 50%, or at least 60%, or at least 70%, or at least 80% of the heat provided to the mixture of steam and feed precursor in the reactor 314. In an embodiment, the heat supplied to the mixture of steam and feed precursor in the pre-reforming reactor 314 may consist essentially of heat exchanged between the anode and cathode exhaust streams and the mixture of steam and feed precursor in the reactor 314. In an embodiment of the process, the exchange of heat between the anode and cathode exhaust streams and the mixture of steam and feed precursor in the reactor 314 may be controlled to maintain the temperature of the mixture of steam and feed precursor in a range of from 500° C. to 800° C.

In a preferred embodiment, the heat provided by the anode exhaust stream, or the cathode exhaust stream, or the anode and cathode exhaust streams to the mixture of steam and feed precursor in the pre-reforming reactor 314 is sufficient to drive the pre-reforming/cracking reactions in the reforming reactor 314 such that no other source of heat is required to drive the reactions in the pre-reforming reactor 314. Most preferably, no heat is provided to the mixture of steam and feed precursor in the reactor 314 by electric heating or combustion.

In an embodiment, the anode exhaust stream provides most, or all, of the heat to the mixture of steam and feed precursor in the pre-reforming reactor 314 to drive the vaporization/cracking/reforming reactions in the reactor 314. Metering valves 371 and 370 may be adjusted to control the flow of the anode exhaust stream from the fuel cell 305 to the pre-reformer anode exhaust conduit 320, where the flow of the anode exhaust stream through the valve 370 may be increased and its flow through valve 371 may be decreased to increase flow of the anode exhaust stream into the pre-reformer anode exhaust conduit 320 to provide the heat required to drive the vaporization/cracking/reforming reactions in pre-reforming reactor 314.

In this embodiment only some, or none, of the cathode exhaust stream is required to exchange heat with the mixture of steam and feed precursor in the pre-reforming reactor 314 to drive the vaporization/cracking/reforming reactions. The flow of the cathode exhaust stream through the pre-reforming cathode exhaust conduit 322 in the pre-reforming reactor 314 may be controlled to control the amount of heat provided to the mixture of steam and feed precursor in the pre-reforming reactor 314 from the cathode exhaust stream. Metering valves 411, 412, 429, and 431 may be adjusted to control the flow of the cathode exhaust stream to the pre-reformer cathode exhaust conduit 322 such that the cathode exhaust stream provides the desired amount of heat, if any, to the mixture of steam and feed precursor in the pre-reforming reactor 314. To decrease the flow of the cathode exhaust stream to the pre-reforming reactor 314 through the pre-reformer cathode exhaust conduit 322, valves 412 and 429 may be adjusted to decrease flow of the cathode exhaust through valves 412 and 429 and valves 411 and 431 may be adjusted to increase flow of the cathode exhaust through valves 411 and 431.

Cathode exhaust stream that is not required to heat the mixture of steam and feed in the reforming reactor 301 or pre-reforming reactor 314 may be shunted through line 409 to heat exchanger 405 to heat the oxygen containing gas fed to the cathode 399.

In an embodiment, the cathode exhaust stream provides most, or all, of the heat to the mixture of steam and feed precursor in the pre-reforming reactor 314 to drive the vaporization/cracking/reforming reactions in the reactor 314. Metering valves 411, 412, 429, and 431 may be adjusted to control the flow of the cathode exhaust stream to the pre-reformer cathode exhaust conduit 322 such that the cathode exhaust stream provides the desired amount of heat to the mixture of steam and feed precursor in the reactor 314. To increase the flow of the cathode exhaust stream to the pre-reforming reactor 314 through the pre-reformer cathode exhaust conduit 322, valves 412 and 429 may be adjusted to increase flow of the cathode exhaust stream through valves 412 and 429 and valves 411 and 431 may be adjusted to decrease flow of the cathode exhaust stream through valves 411 and 431.

In this embodiment only some, or none, of the anode exhaust stream is required to exchange heat with the mixture of steam and feed precursor in the pre-reforming reactor 314 to drive the vaporization/cracking/reforming reactions. The flow of the anode exhaust stream through the reforming anode exhaust conduit 320 in the pre-reforming reactor 314 may be controlled to control the amount of heat provided to the mixture of steam and feed precursor in the pre-reforming reactor 314 from the anode exhaust stream. Metering valves 371 and 370 may be adjusted to control the flow of the anode exhaust stream from the fuel cell 305 to the pre-reformer anode exhaust conduit 320, where anode exhaust stream flow through the valve 370 may be decreased and its flow through the valve 371 may be increased to decrease flow of the anode exhaust stream into the pre-reformer anode exhaust conduit 320.

The cooled cathode exhaust stream that has passed through the pre-reformer cathode exhaust conduit 322 may still have a significant amount of heat therein, and may have a temperature of up to 800° C. The cooled cathode exhaust stream may be passed out of the cathode exhaust conduit through outlet 423 to be fed to the oxygen containing gas heat exchanger 405 through line 419 along with any cathode exhaust stream metered to the heat exchanger 405 through valve 411.

In a preferred embodiment, the reforming reactor 301, the pre-reforming reactor 314, and the solid oxide fuel cell 305 may be thermally integrated so the heat from the exothermic electrochemical reaction in the fuel cell 305 is provided to both the reforming region 315 of the reforming reactor 301, to drive the endothermic reforming reaction in the reforming reactor 301, and the pre-reforming region 316 of the pre-reforming reactor 314 to drive the endothermic vaporization/cracking/reforming reactions. The fuel cell 305 may be operatively connected to the reforming reactor 301 and the pre-reforming reactor 314 as described above.

In an embodiment, the pre-reforming anode exhaust conduit(s) 320 may be operatively connected in series with the reforming anode exhaust conduit(s) 319 so that the anode exhaust stream may flow from the anode exhaust outlet 369 of the fuel cell 305 through the pre-reforming reactor 314, then through the reforming reactor 301. Flow of the anode exhaust stream from the pre-reformer anode exhaust conduit(s) 320 to the reformer anode exhaust conduit(s) 319 may be controlled by adjusting valve 368.

In an embodiment, the pre-reforming cathode exhaust conduit(s) 322 of the pre-reforming reactor 314 may be operatively connected in series with the reforming cathode exhaust conduit(s) 317 of the reforming reactor 301 so that the cathode exhaust stream may flow from the cathode exhaust outlet 407 through the pre-reforming reactor 314, then through line 425 into the reformer cathode exhaust conduit 317 of the reforming reactor 301. Flow of the cathode exhaust stream from the pre-reforming reactor 314 into the reforming reactor 301 through line 425 may be controlled by adjusting valve 427.

In another embodiment, the pre-reformer anode exhaust conduit(s) 320 and the reformer anode exhaust conduit(s) 319 may be operatively connected in parallel so the anode exhaust stream may flow from the anode exhaust outlet 365 simultaneously through both the pre-reformer anode exhaust conduit(s) 320 and the reformer anode exhaust conduit(s) 319. Metering valves 371 and 370 may be adjusted so that the anode exhaust stream flows into the reformer anode exhaust conduit(s) 319 and the pre-reformer anode exhaust conduit(s) 320, respectively, at desired rates.

In another embodiment, the pre-reformer cathode exhaust conduit(s) 322 may be operatively connected in parallel with the reformer cathode exhaust conduit(s) 317 so the cathode exhaust stream may flow from the cathode exhaust outlet 407 through the pre-reformer cathode exhaust conduit(s) 422 and the reformer cathode exhaust conduit(s) 417 simultaneously. Metering valves 431 and 429 may be adjusted so that the cathode exhaust stream flows into the reformer cathode exhaust conduit(s) 317 and the pre-reformer cathode exhaust conduit(s) 322, respectively, at desired rates.

The flow of the anode exhaust stream through the pre-reforming reactor 314 and the reforming reactor 301 to provide heat to the reactors 301 and 314 may be controlled by metering valves 370, 371, and 368. Metering valve 370 may be used to control the flow of the anode exhaust stream from the anode exhaust outlet 365 to the pre-reformer anode exhaust conduit(s) 320. Metering valve 371 may be used to control the flow of the anode exhaust stream from the anode exhaust outlet 365 to the reformer anode exhaust conduit(s) 319. Metering valve 368 may be used to control the flow of the anode exhaust stream from the pre-reformer anode exhaust conduit 320 so that the anode exhaust stream may be directed into the reformer anode exhaust conduit 319.

The flow of the cathode exhaust stream through the pre-reforming reactor 314 and the reforming reactor 301 to provide heat to the reactors 301 and 314 may be controlled by metering valves 412, 427, 429, and 431. Metering valve 412 may be used to control the flow of the cathode exhaust stream from the fuel cell cathode exhaust outlet to the pre-reforming reactor 314 and the reforming reactor 301. Metering valve 429 may be used to control the flow of the cathode exhaust stream from the cathode exhaust outlet 407 to the pre-reformer cathode exhaust conduit(s) 322. Metering valve 431 may be used to control the flow of the cathode exhaust stream from the cathode exhaust outlet 407 to the reformer cathode exhaust conduit(s) 317. Metering valve 427 may be used to control the flow of the cathode exhaust stream from the pre-reformer cathode exhaust conduit 322 so that the cathode exhaust stream may be directed into the reformer cathode exhaust conduit 317.

In this embodiment of the process of the present invention, relatively little carbon dioxide may be generated per unit of electricity produced by the process, in particular, from generation of the first gas stream from the hydrocarbon feed and from oxidation of carbon monoxide to carbon dioxide in the fuel cell 305. First recycling the hydrogen from the anode exhaust stream in the second gas stream to the fuel cell 305 reduces the amount of hydrogen required to be produced by the reforming reactor 301, thereby reducing attendant carbon dioxide by-product production. Second, the thermal integration of the reforming reactor 301, and optionally the pre-reforming reactor 314, with the fuel cell 305—wherein the heat produced in the fuel cell 305 is transferred within the reforming reactor 301 and optionally within the pre-reforming reactor 314 by the anode and/or cathode exhausts from the fuel cell 305—reduces the energy required to be provided to drive the endothermic reforming and pre-reforming reactions, reducing the need to provide such energy, for example by combustion, thereby reducing the amount of carbon dioxide produced in providing energy to drive the reforming and pre-reforming reactions.

In this embodiment of the process of the present invention, carbon dioxide may be generated at a rate of no more than 400 grams per kilowatt-hour (400 g per kWh) of electricity generated. In a preferred embodiment, carbon dioxide is generated in the process of the present invention at a rate of no more than 350 g per kWh, and in a more preferred embodiment, carbon dioxide is generated in the process of the present invention at a rate of no more than 300 g per kWh.

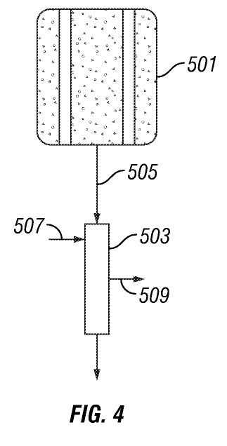

In another embodiment, the process of the present invention utilizes a system including a thermally integrated steam reformer, a hydrogen-separating device located exterior to the steam reformer, and a solid oxide fuel cell. Referring now to FIG. 4, the system for practicing the process of this embodiment is similar to that shown in FIG. 2 or in FIG. 3, except that the high temperature hydrogen-separation device 503 is not located in a reforming reactor 501, but is operatively coupled to the reforming reactor 501 so that a reformed product gas containing hydrogen and carbon oxides formed in the reforming reactor 501 and unreacted hydrocarbons and steam are passed through line 505 to the high temperature hydrogen-separation device 503. The high temperature hydrogen-separation device 503 is preferably a tubular hydrogen permeable membrane apparatus as described above.

A first gas stream containing hydrogen is separated from the reformed product gas and unreacted steam and hydrocarbons by the hydrogen separation device 503. A steam sweep gas may be injected into the hydrogen separation device 503 through line 507 to facilitate separation of the first gas stream. The first gas stream may be fed from the hydrogen separation device to a heat exchanger, and subsequently to a condenser, and then to the solid oxide fuel cell as described above. A second gas stream comprising hydrogen is separated from the anode exhaust of the fuel cell and fed back into the fuel cell as described above.

Gaseous non-hydrogen reformed products and unreacted feed may be separated as a gaseous stream from the hydrogen separation device 503 via line 509. The non-hydrogen reformed products and unreacted feed may include carbon dioxide, water (as steam), and small amounts of carbon monoxide, hydrogen, and unreacted hydrocarbons.

The non-hydrogen gaseous stream separated from the hydrogen separation device 503 may be a high pressure carbon dioxide gas stream containing at least 0.9, or at least 0.95, or at least 0.98 mole fraction carbon dioxide on a dry basis, and having a pressure of at least 1 MPa, or at least 2 MPa, or at least 2.5 MPa. The high pressure carbon dioxide stream may be treated as described above with respect to the high pressure carbon dioxide stream separated from the reforming reactor with the hydrogen separation membrane located therein.

The remainder of the process utilizing the hydrogen separation device 503 located outside of the reforming reactor 501 may be practiced in the same manner as the process described above with respect to the solid oxide fuel cell and the reforming reactor containing the hydrogen separation membrane therein, with or without a pre-reforming reactor.

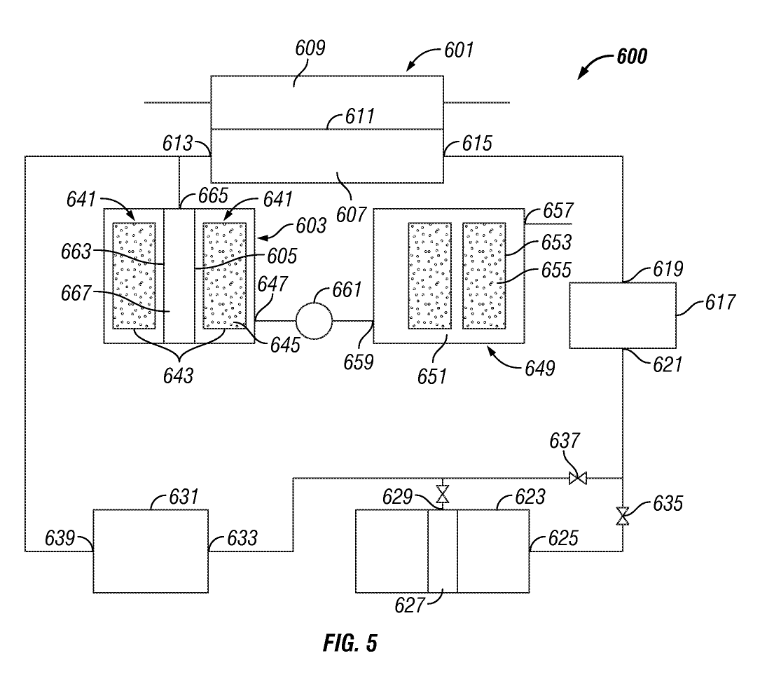

Referring now to FIG. 5, a system 600 in accordance with the present invention is shown. The system 600 includes a solid oxide fuel cell 601, a reforming reactor 603, and a hydrogen separation apparatus 605. The solid oxide fuel cell 601 comprises an anode 607, a cathode 609, and an electrolyte 611, where the electrolyte 611 is positioned between, contacts, and separates the anode 607 and the cathode 609. Solid oxide fuel cells useful in the system of the present invention, their anodes, cathodes, and electrolytes are described above.

The anode 607 of the solid oxide fuel cell 601 has an anode inlet 613 through which a fuel may be fed to the anode 607, and an anode exhaust outlet 615 through which spent fuel is exhausted from the anode 607. The anode exhaust outlet 615 is operatively connected in gaseous communication with the anode inlet 613 so that hydrogen in the anode exhaust may be recycled back into the anode 607 to avoid wasting the electrochemical potential of hydrogen in the anode exhaust.

In a preferred embodiment, the system 600 includes one or more heat exchangers 617 to cool the anode exhaust prior to feeding the anode exhaust back to the anode 607 through the anode inlet 613. The heat exchanger(s) 617 may cool the anode exhaust with any cooling medium, however, as described above, preferably the anode exhaust is cooled by exchanging heat with a feed or a feed precursor and/or steam that is to used in the reforming reactor 603 to produce hydrogen to be fed to the fuel cell 601. Alternatively, the anode exhaust may first be passed through the reforming reactor 603 in an anode exhaust conduit (not shown) as described above to initially cool the anode exhaust and provide heat to the reforming reactor 603 prior to being cooled in the heat exchanger(s) 617.

If the system 600 includes one or more heat exchangers 617, the heat exchangers 617 are operatively connected in the system 600 to cool the anode exhaust stream as the anode exhaust stream flows from the anode exhaust outlet 615 to the anode inlet 613. An inlet 619 of the heat exchanger 617 is operatively coupled in gaseous communication with the anode exhaust outlet 615 of the fuel cell 601, and an outlet 621 of the heat exchanger 617 is operatively connected in gaseous communication with the anode inlet 613. If more than one heat exchanger 617 is present in the system 600 the heat exchangers 617 may be arranged in series, where the heat exchanger inlet 619 of the first heat exchanger 617 is operatively connected in gaseous communication with the anode exhaust outlet 615 of the fuel cell 601, and the heat exchanger outlet 621 of the last of the heat exchangers 617 is operatively connected in gaseous communication with the anode inlet 613 of the fuel cell 601, where the heat exchanger outlet 621 of each of the serially connected heat exchangers 617, except the final heat exchanger 617 of the series, may be connected in gaseous communication with the heat exchanger inlet 619 of the next heat exchanger 617 in the series.

In an embodiment, a second hydrogen separation apparatus 623 may be operatively connected in gaseous communication between the heat exchanger outlet 621 and the anode inlet 613 to separate hydrogen from the anode exhaust exiting the heat exchanger(s) 617 prior to feeding the hydrogen to the anode inlet 613 of the fuel cell 601. The second hydrogen separation apparatus 623 may have an inlet 625 coupled in gaseous communication with the heat exchanger outlet 621 (or the heat exchanger outlet of the final heat exchanger in a series of more than one heat exchanger) through which cooled anode exhaust gas may enter the second hydrogen separation apparatus 623. The second hydrogen separation apparatus 623 may also have a second member 627 that is selectively permeable to hydrogen, where the second member 627 is coupled in gaseous communication with the inlet 625 of the second hydrogen separation apparatus 623. The second hydrogen separation apparatus may also have a second hydrogen gas outlet 629 in gaseous communication with second member 627 of the second hydrogen separation apparatus 623 and coupled in gaseous communication with the anode inlet 613 of the fuel cell 601. The second member 627 of the second hydrogen separation apparatus 623 may be interposed between the second hydrogen separation apparatus inlet 625 and the second hydrogen gas outlet 629 to permit selective flow of hydrogen from the inlet 625 to the outlet 629, and thence to the anode inlet 613 of the fuel cell 601. In one embodiment, the second member 627 is a membrane that is selectively permeable to hydrogen, such as the membranes that are selectively permeable to hydrogen described above. In another embodiment, the second hydrogen separation apparatus is a conventional pressure swing absorption apparatus having an inlet 625 and an outlet 629.

In an embodiment, a condenser 631 may be operatively connected in gaseous communication between the heat exchanger outlet 621 or the second hydrogen gas outlet 629 and the anode inlet 613 to separate hydrogen from water/steam in the anode exhaust exiting the heat exchanger(s) 617 or the second hydrogen separation apparatus 623 prior to feeding the hydrogen to the anode inlet 613 of the fuel cell 601. As noted above, when hydrogen is supplied as fuel to the fuel cell 601 the anode exhaust contains unreacted hydrogen and water produced by oxidation of hydrogen in the fuel cell. The cooled anode exhaust exiting the heat exchanger(s) 617 may be cooled in the condenser 631 sufficiently to condense and remove water from the anode exhaust stream and thereby provide a high hydrogen content gas stream to the anode 607 of the fuel cell through the anode inlet 613. Further, a steam sweep gas may be used to help separate hydrogen from the second member 627 of the second hydrogen separation apparatus 623, and the hydrogen gas stream and steam sweep gas from the second hydrogen separation apparatus 623 may be cooled in the condenser 631 sufficiently to condense and separate the steam sweep gas from the hydrogen gas stream to be provided to the anode 607 of the fuel cell 601.

In an embodiment, where the second hydrogen separation apparatus 623 is not present or metering valves 635 and 637 are adjusted to direct the flow of the cooled anode exhaust gas from the heat exchanger(s) 617 to the condenser 631, the inlet 633 of the condenser 631 may be connected to the outlet 621 of the heat exchanger 617, or the last of the heat exchangers 617 in a series of heat exchangers 617 if more than one heat exchanger 617 is present, so the cooled anode exhaust may flow from the heat exchanger(s) 617 to the condenser 631. The outlet 639 of the condenser 631 may be connected in gaseous communication to the anode inlet 613 so that a substantially water-free hydrogen-rich gas may be passed from the condenser 631 to the anode 607 of the fuel cell 601.

In another embodiment, where steam sweep gas is used to help separate a hydrogen gas stream from the second hydrogen separation apparatus 623, the inlet 633 of the condenser 631 may be connected in gaseous communication to the hydrogen gas outlet 629 of the second hydrogen separation apparatus 623 so the steam sweep gas may be separated from the hydrogen gas stream in the condenser 631. The outlet 639 of the condenser 631 may be connected to the anode inlet 613 so that a substantially sweep gas-free hydrogen rich-gas may be passed from the condenser 631 to the anode 607 of the fuel cell 601.

The system 600 includes a reforming reactor 603 that provides hydrogen fuel to the anode 607 of the fuel cell 601. The reforming reactor 603 includes a reforming region 641 that is adapted to reform a vaporized mixture of steam and a feed comprising one or more hydrocarbons to produce hydrogen. The reforming region 641 includes a reforming catalyst bed 643 with a reforming catalyst 645 therein, where the reforming catalyst may be used to assist in the reforming of the vaporized mixture of steam and feed in the reforming region 641. Reforming catalysts 645 that may be used in the reforming catalyst bed 643 are described above. The reforming reactor 603 includes one or more reforming inlets 647 that are coupled in gaseous communication with the reforming region 641, and through which steam, a feed comprising one or more gaseous hydrocarbons, or a mixture of steam and a feed comprising one or more gaseous hydrocarbons may be introduced into the reforming region 641.

Optionally, the system 600 may include a pre-reforming reactor 649 for converting a feed precursor to a feed useful in the reforming reactor 603. The pre-reforming reactor 649 may include a pre-reforming region 651 that is adapted to receive a liquid or vaporized mixture of steam and a feed precursor comprising one or more hydrocarbons to produce a feed to be provided to the reforming reactor 603. The pre-reforming region includes a pre-reforming catalyst bed 653 with a pre-reforming catalyst 655 therein, where the pre-reforming catalyst may be used to assist in the pre-reforming of the vaporized mixture of steam and feed precursor to form the feed. Pre-reforming catalysts that may be used in the pre-reforming catalyst bed 653 are described above. The pre-reforming reactor 649 includes one or more pre-reforming stream inlets 657 coupled in gas/fluid communication with the pre-reforming region 651 and adapted to receive a feed precursor comprising one or more hydrocarbons, steam, or a mixture thereof and communicate the steam, feed precursor, or mixture thereof to the pre-reforming region 651. The pre-reforming reactor 649 may include an outlet 659 operatively coupled in gaseous communication with the reforming region inlet 647 of the reforming reactor 603 to supply feed formed in the pre-reforming reactor 649 to the reforming reactor 603. In one embodiment, a compressor 661 may be included in the system 600, where the compressor 661 is operatively connected in gaseous communication between the pre-reforming reactor outlet 659 and the reforming region inlet 647 of the reforming reactor 603.

The system 600 also includes a hydrogen separation apparatus 605 for separating hydrogen produced in the reforming reactor 603, where the hydrogen separated in the hydrogen separation apparatus 605 is provided to the anode 607 of the fuel cell 601. The hydrogen separation apparatus 605 includes a member 663 that is selectively permeable to hydrogen, and a hydrogen gas outlet 665. In an embodiment, the member 663 that is selectively permeable to hydrogen is located in the reforming region 641 of the reforming reactor 603 in gaseous communication with the reforming region 641 so that hydrogen in the reforming region 641 produced by reforming and/or water-gas shift reactions in the reforming region 641 may be separated from other gaseous compounds in the reforming region 641 through the member 663. In a preferred embodiment the hydrogen separation apparatus is a high-temperature hydrogen separation membrane, as described above, where the member 663 is the hydrogen-selective, hydrogen-permeable wall of the membrane.

The hydrogen gas outlet 665 of the hydrogen separation apparatus 605 is located in gaseous communication with the hydrogen permeable member 663 of the hydrogen separation apparatus 605, preferably through a hydrogen conduit 667. The hydrogen permeable member 663 is interposed between the reforming region 641 of the reforming reactor 603 and the hydrogen gas outlet 665 and the hydrogen conduit 667 to permit selective flow of hydrogen from the reforming region 641 through the hydrogen permeable member 663 to hydrogen conduit 667 and out of the hydrogen separation apparatus 605 and the reforming reactor 603 through the hydrogen gas outlet 665.

The hydrogen gas outlet 665 is operatively coupled in gaseous communication with the anode inlet 613 of the fuel cell 601 so that hydrogen produced in the reforming reactor 603 and separated therefrom by the hydrogen separation apparatus 605 may be fed to the anode 607 of the fuel cell 601. In an embodiment, one or more heat exchangers may be coupled in gaseous communication between the hydrogen gas outlet 665 and the anode inlet 613 to cool the hydrogen gas stream exiting the hydrogen gas outlet 665 prior to the hydrogen gas stream entering the anode 607 of the fuel cell 601.

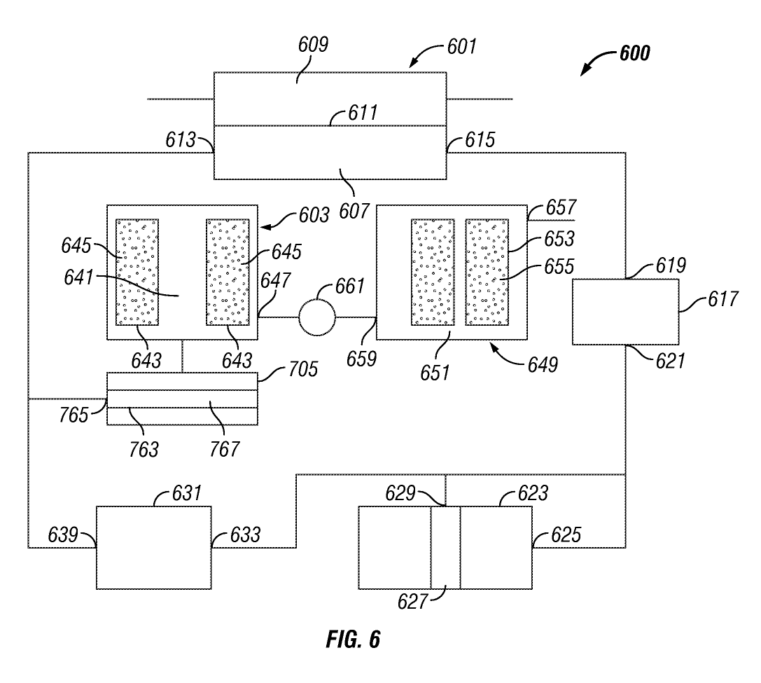

In another embodiment, as shown in FIG. 6, the hydrogen gas separation apparatus 705 may be located outside the reforming reactor 603. The hydrogen-permeable, hydrogen-selective member 763 may be operatively coupled in gaseous communication with the reforming region 641 of the reforming reactor 603 so the reformed gas products may pass from the reforming region 641 of the reforming reactor 603 to the member 763 so hydrogen may be separated from the reformed product gas by the member 763. In one embodiment, the member 763 may be a high temperature hydrogen-permeable, hydrogen-selective membrane, as described above. In another embodiment, the member 763 may be a pressure swing adsorber. In an embodiment, particularly if the member 763 is a pressure swing adsorber, one or more heat exchangers may be coupled in gaseous communication between the reforming region 641 of the reforming reactor 603 and the member 763 to cool the reformed product gas prior to separating hydrogen from the reformed product gas with the member 763.

The hydrogen gas outlet 765 of the hydrogen separation apparatus 705 is located in gaseous communication with the hydrogen permeable member 763 of the hydrogen separation apparatus 705, preferably through a hydrogen conduit 767. The hydrogen permeable member 763 is interposed between the reforming region 641 of the reforming reactor 603 and the hydrogen gas outlet 765 and the hydrogen conduit 767 to permit selective flow of hydrogen from the reforming region 641 through the hydrogen permeable member 763 to hydrogen conduit 767 and out of the hydrogen separation apparatus 705 through the hydrogen gas outlet 765.

The hydrogen gas outlet 765 is operatively coupled in gaseous communication with the anode inlet 613 of the fuel cell 601 so that hydrogen produced in the reforming reactor 603 and separated therefrom by the hydrogen separation apparatus 705 may be fed to the anode 607 of the fuel cell 601. In an embodiment, one or more heat exchangers may be coupled in gaseous communication between the hydrogen gas outlet 765 and the anode inlet 613 to cool the hydrogen gas stream exiting the hydrogen gas outlet 765 prior to the hydrogen gas stream entering the anode 607 of the fuel cell 601.

In an embodiment, the system of the present invention may be a system as depicted in FIG. 1 and described above.

In an embodiment, the system of the present invention may be a system as depicted in FIG. 2 and described above.

In an embodiment, the system of the present invention may be a system as depicted in FIG. 3 and described above.

That which is claimed is:

1. A process for generating electricity, comprising:
feeding a first gas stream containing hydrogen at a selected rate to an anode of a solid oxide fuel cell;
feeding a second gas stream containing hydrogen at a selected rate to the anode of the solid oxide fuel cell;
in the anode, mixing the first gas stream and the second gas stream with an oxidant at one or more anode electrodes of the solid oxide fuel cell to generate electricity at an electrical power density of at least 0.4 W/cm²;
separating an anode exhaust stream comprising hydrogen and water from the anode of the solid oxide fuel cell; and
separating the second gas stream from the anode exhaust stream, said second gas stream comprising hydrogen separated from the anode exhaust stream;
wherein the rates that the first gas stream and the second gas stream are fed to the anode are independently selected so the ratio of the amount of water formed in the fuel cell to the amount of hydrogen in the anode exhaust stream is at most 1.0.

2. The process of claim 1 wherein the rates that the first gas stream and the second gas stream are fed to the anode are independently selected so the ratio of the amount of water formed in the fuel cell to the amount of hydrogen in the anode exhaust stream is at most 0.75.

3. The process of claim 1 wherein the first gas stream is selected to contain at least 0.7 mole fraction hydrogen.

4. The process of claim 1 wherein the first gas stream is selected to contain at most 0.15 mole fraction carbon oxides.

5. The process of claim 1 wherein the second gas stream fed to the anode comprises at least 0.9 mole fraction hydrogen.

6. A process for generating electricity, comprising:
feeding a first gas stream containing hydrogen at a selected rate to an anode of a solid oxide fuel cell;
feeding a second gas stream containing hydrogen at a selected rate to the anode of the solid oxide fuel cell;
in the anode, mixing the first gas stream and the second gas stream with an oxidant at one or more anode electrodes of the solid oxide fuel cell to generate electricity at an electrical power density of at least 0.4 W/cm²;
separating an anode exhaust stream comprising hydrogen and water from the anode of the solid oxide fuel cell; and
separating the second gas stream from the anode exhaust stream, said second gas steam comprising hydrogen from the anode exhaust stream;
wherein the rates that the first gas stream and the second gas stream are fed to the anode are independently selected so that the anode exhaust stream contains at least 0.6 mole fraction hydrogen.

7. The process of claim 6 wherein the rates that the first gas stream and the second gas stream are fed to the anode are independently selected so that the anode exhaust stream contains at least 0.7 mole fraction hydrogen.

8. The process of claim 6 wherein the first gas stream is selected to contain at least 0.7 mole fraction hydrogen.

9. The process of claim 6 wherein the first gas stream is selected to contain at most 0.15 mole fraction carbon oxides.

10. The process of claim 6 wherein the second gas stream fed to the anode comprises at least 0.9 fraction hydrogen.

11. A process for generating electricity, comprising:
feeding a first gas stream containing a hydrogen source at a selected rate to an anode of a solid oxide fuel cell;
feeding a second gas stream containing hydrogen at a selected rate to the anode of the solid oxide fuel cell;
in the anode, reforming the first gas stream to provide hydrogen;
in the anode, mixing the reformed first gas stream and the second gas stream with an oxidant at one or more anode electrodes of the solid oxide fuel cell to generate electricity at an electrical power density of at least 0.4 W/cm²;
separating an anode exhaust stream comprising hydrogen and water from the anode of the solid oxide fuel cell; and
separating the second gas stream from the anode exhaust stream, said second gas stream comprising hydrogen from said anode exhaust stream;
wherein the rates that the first gas stream and the second gas stream are fed to the anode are independently selected so the ratio of amount of water formed in the fuel cell to the amount of hydrogen in the anode exhaust stream is at most 1.0.

12. The process of claim 11 wherein the rates that the first gas stream and the second gas stream are fed to the anode are independently selected so the ratio of the amount of water formed in the fuel cell to the amount of hydrogen in the anode exhaust stream is at most 0.75.

13. The process of claim 11 wherein the hydrogen source of the first gas stream comprises a hydrocarbon.

14. The process of claim 11 wherein the first gas stream further comprises steam.

15. The process of claim 11 wherein the second gas stream fed to the anode comprises at least 0.8 mole fraction hydrogen.
